(19) United States
(12) Patent Application Publication
(10) Pub. No.: US 2026/0350389 A1
(43) Pub. Date: Nov. 5, 2026

(54) Recognition-Theoretic Loss Function for Machine-Learning Models: Four-Term Objective With Fixed Coefficients Derived From Recognition-Physics Constants

(71) Applicant: Jonathan Washburn, Austin, TX (US)

(72) Inventor: Jonathan Washburn, Austin, TX (US)

(21) Appl. No.: 19/662,823

(22) Filed: Apr. 29, 2026

Related U.S. Application Data
(60) Provisional application No. 63/797,332, filed on Apr. 30, 2025.

(51) Int. Cl. G06N 3/08; G06N 3/042; G06N 3/0455; G06N 3/0464

(52) U.S. Cl. CPC G06N 3/08; G06N 3/042; G06N 3/0455; G06N 3/0464

(57) ABSTRACT

A machine-learning training objective combines a data-fit loss with a recognition-cost coupling term, a phi-depth resonance term, and an action-gradient penalty term. A scalar activation-energy field psi is derived from an internal model representation of a machine-learning model. A recognition cost field C_RP is computed from psi through a pipeline in which a Delta-based structural ratio X is normalized by X_opt and evaluated with a J-cost function. A total loss is formed from the data-fit term, the recognition-cost coupling term, the phi-depth resonance term, and the action-gradient penalty term, and model parameters are updated using gradients of the total loss. In disclosed embodiments, coefficient relationships are fixed rather than tuned, including alpha_2=X_opt=phi/pi and alpha_4=X_opt\hat{ }2, thereby avoiding tuning of loss-term weights while providing recognition-cost coupling, depth-weighted resonance, and stabilization behavior during training.

### CROSS-REFERENCE TO RELATED APPLICATIONS

This application claims the benefit of U.S. Provisional Patent Application No. 63/797,332, filed Apr. 30, 2025, the entire disclosure of which is incorporated herein by reference.

### BACKGROUND OF THE INVENTION

The invention relates to machine-learning optimization and neural-network training, and more particularly to a recognition-theoretic loss function for training machine-learning models. More specifically, the invention relates to a training objective in which a data-fit term is combined with disclosed coupling, resonance, and action-gradient terms whose coefficient relationships are fixed by Recognition-Physics constants, including X_opt=phi/pi and phi, thereby avoiding tuning of loss-term weights.

Conventional training objectives such as mean squared error, cross-entropy, Kullback-Leibler divergence, focal loss, Dice-plus-cross-entropy losses, and other composite losses often require manually chosen, heuristically selected, or search-derived coefficients. In many implementations, such coefficient selection requires repeated full training runs across different settings, thereby increasing compute burden, elongating development cycles, and reducing reproducibility across datasets, architectures, and execution environments.

Standard losses generally optimize data fit but do not couple training to the disclosed recognition cost functional C_RP, do not impose the disclosed phi-hierarchical depth contribution, do not impose the disclosed action-gradient penalty tied to recognition cost, and do not provide a fixed, theory-determined basis for selecting loss-term coefficients. As a result, conventional objectives typically rely on arbitrary or empirically tuned weighting choices rather than a fixed coefficient structure determined by the disclosed framework.

Accordingly, a need exists for a machine-learning training objective that preserves ordinary data-fit behavior while adding disclosed coupling, resonance, and action-gradient terms whose coefficient relationships are fixed rather than tuned. A further need exists for such a loss function to avoid arbitrary loss-weight search while introducing the disclosed structural and stability behavior through a recognition-cost coupling term weighted by X_opt, a phi-depth resonance term weighted by phi\hat{ }(−n/2), and an action-gradient penalty weighted by X_opt\hat{ }2.

The invention does not merely add arbitrary penalties to a standard objective. Rather, the invention provides a disclosed recognition-cost coupling term, a disclosed phi-depth resonance term, and a disclosed action-gradient penalty in which the operative coefficient relationships are fixed by stated Recognition-Physics conditions. In particular, alpha_2/alpha_1=X_opt is the unique ratio that makes the stationary-action condition homogeneous, phi\hat{ }(−n/2) follows from phi-hierarchical spacing across depth, and alpha_4=X_opt\hat{ }2 fixes the action-gradient penalty scale relative to the other terms. In this manner, the disclosed framework provides fixed coefficient relationships rather than tuned loss-term weights.

### SUMMARY OF THE INVENTION

The invention provides a machine-learning training objective in which a data-fit loss is combined with a recognition-cost coupling term, a phi-depth resonance term, and an action-gradient penalty term. A scalar activation-energy field psi is derived from an internal model representation. A recognition cost field C_RP is computed from psi through a disclosed X-and-J pipeline. The operative coefficient relationships are fixed rather than tuned. In operation, the disclosed objective is executed within a machine-learning training pipeline that derives psi from internal model representations, computes C_RP through a topology-matched discrete operator and J-cost evaluation, forms a total loss from the resulting machine-computed terms, and updates model parameters using gradients of that total loss, thereby changing subsequent machine behavior during training.

In one load-bearing form, the training objective includes a data-fit term, a fixed-coefficient coupling between psi and C_RP, a fixed-weight depth-dependent resonance contribution formed from summed psi values at a selected layer, and a fixed-coefficient action-gradient penalty based on variation of C_RP with respect to psi. In one disclosed structure, the coupling is alpha_2<psi, C_RP>, the resonance contribution is phi\hat{ }(−n/2) sum_j psi_j, and the action-gradient penalty is alpha_4∥grad_psi C_RP∥\hat{ }2.

In one exact form, the loss is: L_RT=L_data+alpha_2<psi, C_RP>+phi\hat{ }(−n/2) sum_j psi_j+alpha_4∥grad_psi C_RP∥\hat{ }2 where alpha_2=X_opt=phi/pi, alpha_4=X_opt\hat{ }2, C_RP(x)=J(X(x)/X_opt), X(x)=|Delta_x psi(x)|/(psi(x)+epsilon), and J(z)=0.5(z+1/z)−1.

In this exact form, the loss contains exactly four terms. C_RP is minimized when X=X_opt. The coefficient relationships are fixed and fully determined by the stated conditions of the disclosed framework.

In certain embodiments, psi is derived from norm-squared hidden activations or other scalarized internal representations, and C_RP is computed using a discrete operator matched to the underlying data topology, including one-dimensional second-difference, two-dimensional Laplacian, and graph-Laplacian embodiments. One or more selected layers may be used.

Non-limiting disclosed advantages include elimination of loss-term weight tuning, improved convergence in disclosed benchmark examples, low runtime overhead, self-similar structure in certain disclosed examples, compatibility with software training frameworks, and optional hardware mappability.

Formal verification in Lean proves or supports an exact four-term objective, resonance-weight decay with depth, C_RP minimum at X=X_opt, fixed coefficients alpha_2=phi/pi and alpha_4=(phi/pi)\hat{ }2, action-gradient semantics with respect to psi, a bounded overhead result, and the phi identity.

### BRIEF DESCRIPTION OF THE DRAWINGS

FIG. 1 illustrates a high-level training environment in which input data are processed by a machine-learning model to generate predictions and internal representations, from which psi is derived and used to compute the disclosed loss for parameter updating.

FIG. 2 illustrates a loss pipeline overview including a data-fit term, derivation of psi, computation of C_RP from psi, and formation of a total loss under fixed coefficient relationships.

FIG. 3 illustrates an exact four-term loss architecture including a data-fit term, a recognition-cost coupling term, a resonance term, an action-gradient penalty term, and fixed coefficient relationships.

FIG. 4 illustrates computation of C_RP from psi through Delta psi, X, X_opt normalization, and J-cost evaluation.

FIG. 5 illustrates psi derivation and scalarization embodiments across different model families.

FIG. 6 illustrates single-layer and multi-layer embodiments including selection of one or more layers and summation of per-layer contributions.

FIG. 7 illustrates topology-specific Delta variants including sequence, image, and graph embodiments.

FIG. 8 illustrates an end-to-end training workflow from batch input through loss computation and parameter update.

FIG. 9 illustrates software and optional hardware implementation architecture including software framework integration and optional accelerator support.

FIG. 10 illustrates demonstrated validation outputs including convergence, final metric comparisons, and selected structural diagnostics.

FIG. 11 illustrates formal-verification anchors and their relationship to claim-support structure.

### DETAILED DESCRIPTION OF THE INVENTION

The present invention relates to a recognition-theoretic loss function for training machine-learning models. More particularly, the invention provides a training objective in which a conventional data-fit term is combined with a recognition-cost coupling term, a phi-depth resonance term, and an action-gradient penalty term, with operative coefficient relationships fixed by Recognition-Physics constants rather than selected by hyperparameter tuning. In preferred embodiments, the disclosed loss function is used as a drop-in replacement for a conventional supervised loss while preserving the existing model architecture, optimizer, data loader, learning-rate schedule, and batch size, such that only the loss function changes. Even in such drop-in use, the disclosed loss function changes machine training behavior by altering how hidden-layer activations are processed into psi, how recognition cost is computed from those activations through the disclosed Delta-to-X-to-J pipeline, and how gradients are propagated to update model parameters in later training iterations.

In broad operation, the invention derives a scalar activation-energy field psi from an internal model representation, computes a recognition cost field C_RP from psi through a disclosed psi-to-X-to-J-to-C_RP chain, combines the resulting recognition-theoretic quantities with a data-fit term under fixed coefficient relationships, and updates model parameters using gradients of the resulting total loss. In this manner, the invention introduces balanced internal structure rather than arbitrary weight decay.

In one exact embodiment, the disclosed loss function has four terms with fixed coefficients and is given by:

L_RT=L_data+alpha_2<psi, C_RP>+phi\hat{ }(−n/2) sum_j psi_j+alpha_4∥grad_psi C_RP∥\hat{ }2

where L_data is a standard data-fit term, psi_j is a scalar activation-energy at position j for layer n, C_RP is a recognition cost field computed from psi by the disclosed J-cost pipeline, alpha_2=X_opt=phi/pi, phi\hat{ }(−n/2) is a golden-ratio resonance weight for layer index n, alpha_4=X_opt\hat{ }2, and grad_psi C_RP is a gradient of C_RP with respect to psi. In this exact embodiment, all operative coefficients derive from phi and pi, and there are no tunable loss-term weights.

In one broader embodiment, the total loss may be expressed as a sum over one or more selected layers, such that model predictions and targets contribute through a data-fit term, and each selected layer contributes through a recognition-cost coupling term, a phi-depth resonance contribution, and an action-gradient penalty contribution. In one disclosed formulation, model parameters theta are trained according to:

L_RT(theta)=sum_i ell(y_hat_i, y_i)+sum_n[X_opt times sum_j psi_n, j C_RP, n(x_j)+phi\hat{ }(−n/2) times sum_j psi_n, j+X_opt\hat{ }2 times sum_j∥partial C_RP, n(x_j)/partial psi_n, j∥\hat{ }2]

where theta denotes model parameters, y_hat_i and y_i denote predictions and targets, psi_n, j denotes scalar activation-energy at layer n and position j, C_RP, n(x_j) denotes recognition cost at position j computed from psi_n, and n is summed over one or more selected layers. This broader form preserves the same four-part structure while expressly supporting single-layer and multi-layer embodiments. In multi-layer embodiments, the recognition-cost coupling term, the phi-depth resonance contribution, and the action-gradient penalty contribution may each be computed separately for each selected layer and then aggregated across the selected layers to form corresponding portions of the total loss.

The disclosed coefficient relationships are not arbitrary. In one preferred derivational framing, alpha_2/alpha_1=X_opt is the unique ratio that makes the stationary-action condition homogeneous. The resonance exponent −n/2 follows from golden-ratio eigen-spacing so that deeper layers have exponentially smaller resonance contributions, thereby forming a phi-hierarchical loss contribution across depth. The coefficient alpha_4=X_opt\hat{ }2 sets a fixed Recognition-Physics scale for the action-gradient penalty term so that its magnitude is commensurate with the other terms under the same normalization. In one preferred embodiment, X_opt=phi/pi is approximately 0.5149 and alpha_4=X_opt\hat{ }2 is approximately 0.2651.

In one derivational embodiment, the data-fit term is normalized to coefficient alpha_1=1, the recognition-cost coupling term is evaluated under the disclosed recognition-cost normalization, and the stationary-action condition is required to remain homogeneous across the data-fit and recognition-cost portions of the objective. Under that normalization, the coupling coefficient is fixed as alpha_2=X_opt. The action-gradient coefficient is then fixed as alpha_4=X_opt\hat{ }2 so that the state-sensitivity penalty is scaled by the same recognition-cost normalization applied to the recognition-cost scale and the gradient-response scale. Thus, the disclosed coefficients are computed from fixed expressions of the disclosed framework rather than selected by training-run search over candidate loss weights.

Key properties of the disclosed loss include zero tunable loss-term weights, fixed coefficient relationships derived from phi and pi, support for drop-in use in PyTorch, TensorFlow, and JAX environments, low runtime overhead in disclosed benchmarks, and self-similar structure in certain disclosed learned filters. In disclosed benchmark examples, the loss provides faster convergence on multiple tasks while preserving ordinary training-loop structure.

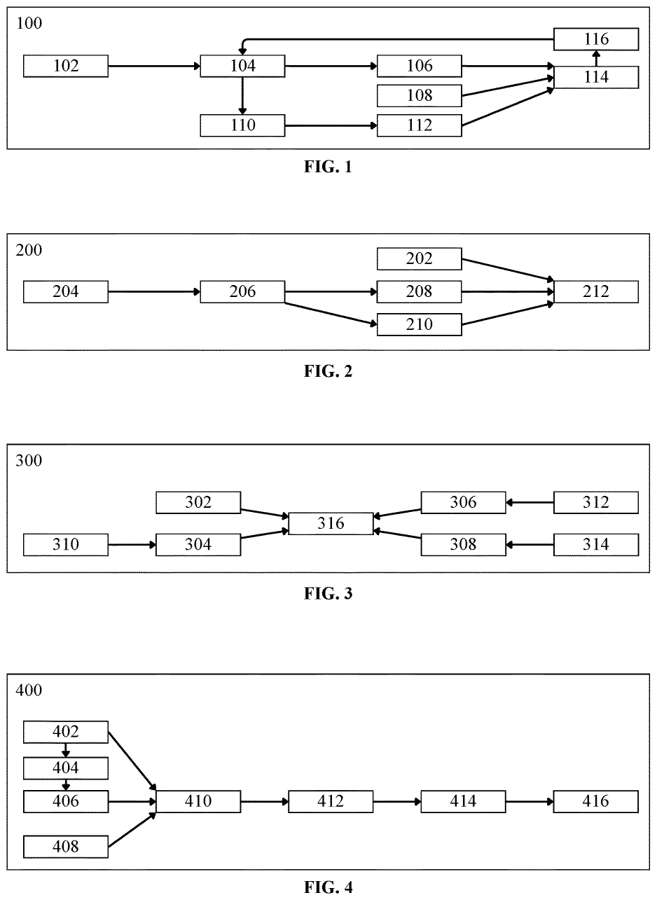

FIG. 1 illustrates a high-level training environment 100 in which a training dataset 102 is provided to a machine-learning model 104. The machine-learning model 104 generates a prediction output 106 and receives or is compared against target data 108. The machine-learning model 104 further provides a hidden representation source 110 from which a scalar activation-energy field psi may be derived. An activation-energy derivation module 112 receives the hidden representation source 110 and derives psi. A loss engine 114 receives at least the prediction output 106, the target data 108, and the derived psi, computes the disclosed recognition-theoretic loss, and provides a resulting total loss. A parameter-update engine 116 receives gradient information based on the total loss and updates parameters of the machine-learning model 104.

The training environment 100 may be implemented in any suitable machine-learning training context, including software-only, software-plus-accelerator, workstation, cloud, distributed, or edge-supported environments. The training dataset 102 may include image data, sequence data, token data, graph data, tabular data, multimodal data, or other machine-learning inputs. The machine-learning model 104 may be a convolutional neural network, Transformer, graph neural network, multilayer perceptron, hybrid network, encoder-decoder architecture, or other trainable model. The prediction output 106 may include class logits, regression values, token predictions, graph predictions, segmentation outputs, similarity outputs, or other task-dependent outputs. The target data 108 may include labels, target values, target sequences, graph annotations, segmentation masks, or other supervisory information.

The hidden representation source 110 may include one or more feature maps, token states, node embeddings, latent states, penultimate activations, or other internal model states. The activation-energy derivation module 112 may derive psi from one selected layer or from a plurality of selected layers. In preferred embodiments, the activation-energy derivation module 112 derives psi by a norm-squared or sum-of-squares reduction over one or more hidden dimensions, channels, or embedding components, such that the resulting psi is a scalar activation-energy field arranged over one or more topology-dependent positions.

The loss engine 114 is preferably configured to compute the full recognition-theoretic objective, including a data-fit term, a recognition-cost coupling term, a phi-depth resonance term, and an action-gradient penalty term. In one exact embodiment, the loss engine 114 computes exactly four terms and combines those terms into the disclosed total loss L_RT. In broader embodiments, the loss engine 114 may compute intermediate quantities including Delta_x psi, X, X/X_opt, C_RP, per-layer resonance contributions, per-layer action-gradient quantities, and one or more aggregated selected-layer contributions. The parameter-update engine 116 then uses gradients of the total loss to update weights, biases, embeddings, kernels, projection matrices, normalization parameters, or other trainable parameters of the machine-learning model 104.

As used herein, model parameters theta may include any trainable values of the machine-learning model 104. Predictions y_hat may denote outputs of the machine-learning model 104. Targets y may denote supervisory values associated with the target data 108. A hidden state h may denote an internal representation contained within or derived from the hidden representation source 110. A scalar activation-energy field psi may denote a scalarized field derived from such internal representations and arranged over one or more positions, tokens, nodes, pixels, or topology-dependent locations. A selected layer may denote a single layer chosen for derivation of psi or evaluation of one or more operative terms, while a selected layer set may denote multiple such layers. Position index j may denote a location within psi, and layer index n may denote a layer location used for depth-dependent weighting.

As further used herein, Delta_x denotes a topology-matched discrete operator applied to psi. X denotes a structural ratio computed from Delta_x psi and psi. C_RP denotes a recognition cost field computed from X through X_opt normalization and J-cost evaluation. J denotes the disclosed cost function J(z)=0.5(z+1/z)−1. X_opt denotes the optimum structural ratio, which in preferred embodiments is phi/pi. L_RT denotes the total recognition-theoretic loss. The phrase action-gradient penalty refers to the penalty based on variation of C_RP with respect to psi. The phrase state sensitivity may be used as explanatory vocabulary, but does not replace action-gradient penalty in operative drafting.

The training environment 100 therefore provides an operational context in which the invention may be practiced using standard training-loop infrastructure while replacing conventional objectives or conventional loss components with the disclosed recognition-theoretic objective. In this respect, the invention is not limited to any one model family, task type, optimizer, or compute platform, but instead centers on the disclosed loss-function structure, the psi derivation process, the recognition-cost computation, the fixed coefficient relationships, and the use of the resulting total loss to update model parameters.

The broad structure introduced in connection with FIG. 1 is refined in subsequent figures. In particular, later figures detail the loss pipeline itself, the exact four-term architecture, the computation of C_RP from psi through Delta_x, X, and J, the derivation of psi across different model families, single-layer and multi-layer embodiments, topology-specific Delta variants, end-to-end workflow stages, software and optional hardware implementation structures, validation outputs, and formal-verification anchors corresponding to the disclosed loss-function kernel.

FIG. 2 illustrates a loss pipeline overview 200 showing how a conventional supervised loss path is combined with the disclosed recognition-theoretic path. The loss pipeline overview 200 includes a data-fit component 202, an internal representation input 204, a psi derivation path 206, a recognition-cost computation path 208, a fixed coefficient relationship set 210, and a total loss output 212.

The data-fit component 202 may receive predictions and targets and may compute a base supervised loss term. In different embodiments, the data-fit component 202 may compute a regression loss, a classification loss, a sequence-modeling loss, a segmentation loss, a graph-learning loss, or another supervised objective. In preferred embodiments, the data-fit component 202 computes mean squared error for regression where the model predictions comprise regression values, and computes cross-entropy for classification where the model predictions comprise class logits. The data-fit component 202 corresponds to the first operative term of the exact four-term objective and preserves ordinary task-fit behavior within the larger recognition-theoretic framework, including regression embodiments using mean squared error and classification embodiments using cross-entropy.

The internal representation input 204 may include one or more hidden states, latent states, feature maps, token states, node states, embedding states, penultimate activations, or other internal model representations from which the scalar activation-energy field psi may be derived. The psi derivation path 206 receives the internal representation input 204 and produces psi by scalarizing one or more internal activations. In preferred embodiments, the psi derivation path 206 applies a norm-squared reduction, a sum-of-squares reduction, or another scalar activation-energy computation. In this way, the psi derivation path 206 transforms architecture-dependent internal model structure into a scalar field suitable for the disclosed recognition-cost computation.

The recognition-cost computation path 208 receives psi from the psi derivation path 206 and computes the disclosed recognition cost field C_RP. In one exact embodiment, the recognition-cost computation path 208 includes computing Delta_x psi, computing X=|Delta_x psi|/(psi+epsilon), normalizing X by X_opt, and evaluating the J-cost function to produce C_RP. Thus, the recognition-cost computation path 208 is the operative path by which internal model structure is converted into the disclosed recognition cost field. The recognition-cost computation path 208 may operate pointwise according to data topology, including positions, tokens, pixels, nodes, or other topology-dependent locations.

The fixed coefficient relationship set 210 provides the coefficient structure by which the total loss is assembled. In one exact embodiment, the fixed coefficient relationship set 210 includes alpha_1=1, alpha_2=X_opt=phi/pi, and alpha_4=X_opt\hat{ }2, together with phi\hat{ }(−n/2) as a fixed depth weighting for the resonance term. In one preferred numeric embodiment, X_opt=phi/pi is approximately 0.5149 and alpha_4=X_opt\hat{ }2 is approximately 0.2651. Accordingly, the loss pipeline overview 200 differs from conventional composite-loss assembly in which weighting coefficients are chosen heuristically or through repeated search.

The total loss output 212 receives contributions from the data-fit component 202, the psi derivation path 206, the recognition-cost computation path 208, and the fixed coefficient relationship set 210. In a broad embodiment, the total loss output 212 represents a machine-learning training objective comprising a data-fit term, a recognition-cost coupling term, a phi-depth resonance term, and an action-gradient penalty term. In an exact embodiment, the total loss output 212 is the exact four-term objective L_RT. The total loss output 212 may then be used in gradient-based parameter updating as described elsewhere herein.

FIG. 3 illustrates an exact loss architecture 300 that more specifically shows the exact-kernel fallback of the invention. The exact loss architecture 300 includes a data-fit term 302, a recognition-cost coupling term 304, a resonance term 306, an action-gradient penalty term 308, a first fixed coefficient relationship 310, a resonance weighting 312, a second fixed coefficient relationship 314, and a total loss output 316. In one exact embodiment, the exact loss architecture 300 implements exactly four operative terms and fixed coefficient relationships corresponding to the disclosed mathematical kernel.

The data-fit term 302 corresponds to L_data and provides the first term of the exact objective. The data-fit term 302 may be computed from predictions and targets and may take the form of mean squared error, cross-entropy, or another disclosed supervised loss term. The recognition-cost coupling term 304 corresponds in one exact embodiment to alpha_2<psi, C_RP>. The resonance term 306 corresponds in one exact embodiment to phi\hat{ }(−n/2) sum_j psi_j. The action-gradient penalty term 308 corresponds in one exact embodiment to alpha_4∥grad_psi C_RP∥\hat{ }2. The total loss output 316 is formed by combining the four exact terms 302, 304, 306, and 308.

The first fixed coefficient relationship 310 may represent alpha_2=X_opt=phi/pi. The resonance weighting 312 may represent phi\hat{ }(−n/2) applied according to layer index n. The second fixed coefficient relationship 314 may represent alpha_4=X_opt\hat{ }2. Together, the fixed coefficient relationship 310, the resonance weighting 312, and the fixed coefficient relationship 314 define the fixed coefficient relationships by which the exact loss architecture 300 operates. These relationships are fixed, not selected by tuning. In particular, alpha_2/alpha_1=X_opt is the unique ratio that makes the stationary-action condition homogeneous, phi\hat{ }(−n/2) provides fixed depth weighting derived from phi-hierarchical spacing across depth, and alpha_4=X_opt\hat{ }2 is a fixed function of X_opt that places the action-gradient penalty at a commensurate scale relative to the other operative terms.

In one exact embodiment, the total loss output 316 is given by:

L_RT=L_data+alpha_2<psi, C_RP>+phi\hat{ }(−n/2) sum_j psi_j+alpha_4∥grad_psi C_RP∥\hat{ }2

where alpha_1=1, alpha_2=X_opt=phi/pi, alpha_4=X_opt\hat{ }2, C_RP(x)=J(X(x)/X_opt), X(x)=|Delta_x psi(x)|/(psi(x)+epsilon), and J(z)=0.5(z+1/z)−1. In this exact embodiment, the total loss output 316 reflects an exact four-term objective rather than an open-ended family of optional penalty additions.

The data-fit term 302 may be understood as preserving ordinary supervised fitting behavior. The recognition-cost coupling term 304 may be understood as tying the scalar activation-energy field psi to the recognition cost field C_RP so that regions of greater activation-energy contribute through the disclosed recognition-cost structure. The resonance term 306 may be understood as introducing phi-hierarchical depth weighting through a per-layer summed psi contribution. The action-gradient penalty term 308 may be understood as penalizing abrupt variation of C_RP with respect to psi. In this way, the exact loss architecture 300 not only identifies the exact mathematical kernel, but also clarifies the distinct operational role of each of the four terms.

The exact loss architecture 300 may also be expressed at a more general intermediate level without departing from the invention. In one load-bearing embodiment, the data-fit term 302 is any disclosed data-fit term, the recognition-cost coupling term 304 is any fixed-coefficient coupling between psi and C_RP, the resonance term 306 is any fixed-weight depth-dependent resonance contribution formed from a summed psi quantity for a selected layer, and the action-gradient penalty term 308 is any fixed-coefficient penalty based on variation of C_RP with respect to psi. Thus, while the exact-kernel embodiment is important for claim support and fallback structure, broader embodiments remain anchored to the same four-part architecture of data-fit, recognition-cost coupling, phi-depth resonance, and action-gradient penalty shown in FIG. 3.

In one preferred derivational ordering, the first term anchors supervised data fit, the second term couples representation energy to recognition cost, the third term imposes phi-depth resonance, and the fourth term regularizes action-gradient behavior of the recognition cost field relative to psi. This ordering is not arbitrary. It corresponds to the disclosed exact-kernel structure and is preserved in the formal verification discussed later herein.

Accordingly, FIG. 2 and FIG. 3 together show both the pipeline-level organization and the exact loss architecture of the invention. FIG. 2 emphasizes how ordinary model outputs and internal representations are transformed into the disclosed objective, while FIG. 3 emphasizes that the disclosed objective has exact four-term structure, fixed coefficient relationships, and a defined total loss output 316 suitable for gradient-based training.

FIG. 4 illustrates a recognition-cost pipeline 400 showing how the recognition cost field C_RP is computed from the scalar activation-energy field psi. The recognition-cost pipeline 400 includes a scalar activation-energy field psi 402, a discrete operator Delta_x 404, a Delta psi field 406, an epsilon stabilization component 408, a structural ratio X 410, an X_opt normalization component 412, a J-cost evaluation component 414, and a recognition cost field C_RP 416. FIG. 4 therefore depicts the disclosed psi-to-X-to-J-to-C_RP computation chain in a more explicit and claim-supportive form.

The scalar activation-energy field psi 402 may be derived from any suitable internal model representation as described elsewhere herein. In broad embodiments, psi 402 is a scalar field defined over one or more topology-dependent locations, including sequence positions, token positions, image positions, graph nodes, spatial coordinates, temporal coordinates, or other discrete model locations. The scalar activation-energy field psi 402 may be produced from a hidden state, feature map, token embedding state, node embedding state, penultimate activation, or other internal representation by scalarization, including norm-squared reduction, sum-of-squares reduction, channel aggregation, embedding-dimension aggregation, or other scalar activation-energy computation.

The discrete operator Delta_x 404 acts on psi 402 to generate the Delta psi field 406. In one preferred embodiment, Delta_x 404 is a one-dimensional second-difference operator used for ordered sequence positions or token positions. In another preferred embodiment, Delta_x 404 is a two-dimensional Laplacian used for image positions or other spatial arrays. In another preferred embodiment, Delta_x 404 is a graph Laplacian used for graph-structured data and node-based representations. More generally, Delta_x 404 may be any topology-matched discrete structural operator that produces a structural-difference field from psi 402. Accordingly, the Delta psi field 406 may represent a second-difference field, a Laplacian-response field, a graph-structural response field, or another discrete structural field depending on the relevant topology.

The Delta psi field 406 is used together with psi 402 and the epsilon stabilization component 408 to form the structural ratio X 410. In one exact embodiment, the structural ratio X 410 is computed according to X(x)=|Delta_x psi(x)|/(psi(x)+epsilon). The epsilon stabilization component 408 provides a small positive constant epsilon used to maintain numerical stability in low-magnitude regions of psi 402. In one embodiment, epsilon is selected in a range from 1e-15 to 1e-6 in the numeric type used for training, and denominator stabilization includes clamping psi 402 to at least epsilon before forming X 410. For one-dimensional second-difference embodiments, boundary positions may be handled by ignoring endpoints, reflecting endpoints, or padding with replicated endpoint values. For two-dimensional Laplacian embodiments, padding may be zero-padding, reflect-padding, or replicate-padding. In some embodiments, the epsilon stabilization component 408 may include denominator flooring, clamping, lower-bound enforcement, or related stabilization operations to avoid instability or undefined behavior where psi 402 is small. In this manner, the epsilon stabilization component 408 ensures that the disclosed structural ratio may be computed robustly across varying model states and training conditions.

In some embodiments, stabilization is applied not only to the denominator used to form X 410, but also to the structural ratio X 410 itself or to the normalized ratio X/X_opt before reciprocal evaluation in the J-cost function. For example, X 410 may be floored, clamped, or otherwise lower-bounded by a positive stabilization value to form a stabilized structural ratio X_stab. In one implementation, X_stab=max(X, epsilon_X), where epsilon_X is a positive stabilization value selected for the numeric precision of the training implementation. The recognition cost field may then be computed using C_RP(x)=0.5(X_stab(x)/X_opt+X_opt/X_stab(x))−1. This avoids undefined reciprocal behavior when Delta_x psi is zero or near zero while preserving the disclosed recognition-cost pipeline and the minimum at the stabilized structural ratio corresponding to X_opt.

The structural ratio X 410 is then processed by the X_opt normalization component 412. In one exact embodiment, the X_opt normalization component 412 computes X/X_opt, where X_opt is the disclosed optimum structural ratio. In one exact coefficient structure, X_opt=phi/pi. In preferred numeric form, X_opt is approximately 0.5149. The X_opt normalization component 412 therefore scales the structural ratio X 410 relative to the disclosed optimum structural level at which recognition cost is minimized. This normalization is important because the downstream J-cost evaluation component 414 operates on the normalized quantity X/X_opt rather than on raw X alone.

The J-cost evaluation component 414 computes the disclosed J-cost function. In one exact embodiment, J(z)=0.5(z+1/z)−1. The J-cost evaluation component 414 receives the normalized structural ratio from the X_opt normalization component 412 and computes a recognition-cost value for each relevant topology-dependent location. The resulting recognition cost values are assembled into the recognition cost field C_RP 416. Thus, in one exact embodiment, the recognition cost field C_RP 416 is defined by C_RP(x)=J(X(x)/X_opt).

The recognition cost field C_RP 416 may be computed pointwise over sequence locations, token locations, pixels, nodes, or other topology-dependent positions. In some embodiments, the recognition cost field C_RP 416 may then be used directly in a pointwise coupling with psi. In other embodiments, the recognition cost field C_RP 416 may be aggregated, combined across selected layers, or otherwise incorporated into the disclosed objective in a manner consistent with the fixed-coefficient coupling structure. In all such embodiments, however, the recognition cost field C_RP 416 remains computed from psi through the disclosed Delta_x-to-X-to-J pipeline shown in FIG. 4.

The recognition-cost pipeline 400 may be understood both mathematically and operationally. Mathematically, the pipeline 400 implements the exact chain C_RP(x)=J(X(x)/X_opt), with X(x)=|Delta_x psi(x)|/(psi(x)+epsilon). Operationally, the pipeline 400 transforms internal scalar activation-energy structure into a recognition cost field that can be coupled back into model training. This transformation distinguishes the invention from conventional regularization techniques that do not compute a recognition cost field from internal activation-energy structure through a disclosed structural-ratio and cost-function chain.

The disclosed J-cost evaluation also provides a clear operational interpretation. In one exact embodiment, the recognition cost field C_RP 416 is minimized when X=X_opt. Accordingly, when the structural ratio X 410 matches the disclosed optimum structural ratio, the recognition cost field C_RP 416 achieves a minimum. Regions for which X 410 is less than X_opt may be understood as under-structured regions, and regions for which X 410 is greater than X_opt may be understood as over-structured regions. Both types of deviation increase the recognition cost. The recognition cost field C_RP 416 therefore favors balanced internal structure rather than arbitrary weight decay.

In one preferred interpretive framing, under-structured regions and over-structured regions are both penalized because the disclosed J-cost is symmetric around the optimum after normalization. Thus, the recognition-cost pipeline is not merely a sparsity penalty or magnitude penalty. Instead, it defines a structural optimum at X_opt and assigns increasing cost to departures on either side of that optimum. This is one reason the disclosed loss behaves differently from conventional penalties that simply suppress activation magnitude or weight magnitude.

The recognition-cost pipeline 400 also supports a strong fallback ladder. At the broadest level, the invention includes receiving a scalar activation-energy field psi 402, computing a structural-difference response through Delta_x 404 and Delta psi field 406, forming a structural ratio X 410 with stabilization 408, normalizing by X_opt using component 412, and evaluating a cost function using component 414 to produce a recognition cost field C_RP 416. At a narrower level, the invention includes the exact expressions X(x)=|Delta_x psi(x)|/(psi(x)+epsilon) and C_RP(x)=J(X(x)/X_opt). At a still narrower level, the invention includes the exact J-cost function J(z)=0.5(z+1 /z)−1 and the exact optimum structural ratio X_opt=phi/pi.

In some embodiments, the recognition-cost pipeline 400 may be applied at a single selected layer. In other embodiments, separate instances of the recognition-cost pipeline 400 may be applied at multiple selected layers. For example, a first selected layer may produce a first psi field and corresponding first recognition cost field, while a second selected layer may produce a second psi field and corresponding second recognition cost field. Such layer-specific recognition cost fields may then be used in per-layer coupling terms, per-layer action-gradient penalties, or aggregated multi-layer embodiments as described elsewhere herein.

The recognition-cost pipeline 400 further provides support for both software and hardware-oriented embodiments. In software embodiments, the scalar activation-energy field psi 402, the Delta_x operator 404, the stabilization 408, the structural ratio X 410, the normalization 412, the J-cost evaluation 414, and the recognition cost field C_RP 416 may be implemented as software functions or tensor operations. In optional hardware-assisted embodiments, one or more of these computations may be mapped to arithmetic units, accelerator logic, or dedicated computational circuitry. Nevertheless, such implementation choices remain subordinate to the disclosed recognition-cost mechanism itself.

Accordingly, FIG. 4 provides a detailed and load-bearing representation of the recognition-cost mechanism of the invention. It shows that the recognition cost field C_RP 416 is not an abstract label or heuristic score, but instead is a computed field derived from psi 402 through Delta_x 404, Delta psi 406, stabilization 408, structural ratio X 410, X_opt normalization 412, and J-cost evaluation 414. This recognition-cost computation is central to the disclosed loss-function kernel and supports both the coupling term and the action-gradient penalty term described elsewhere herein.

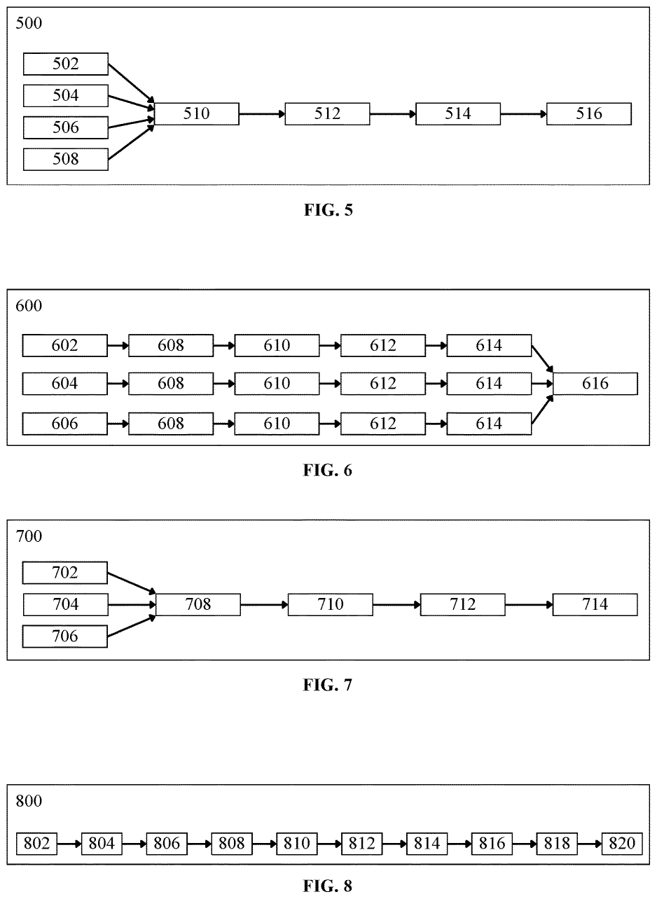

FIG. 5 illustrates a psi derivation view 500 showing preferred scalar activation-energy derivation embodiments across different model families. The psi derivation view 500 includes a convolutional neural network hidden state 502, a Transformer hidden state 504, a graph neural network hidden state 506, a multilayer perceptron hidden state 508, a scalarization operator 510, a squared-activation accumulation component 512, a scalar activation-energy output 514, and a selected psi field 516. FIG. 5 therefore provides a model-family-specific view of how the scalar activation-energy field psi may be derived from internal model representations while preserving the common recognition-cost pipeline described elsewhere herein.

The convolutional neural network hidden state 502 may include a feature map or other spatial hidden representation produced by a convolutional neural network. In one preferred embodiment, the convolutional neural network hidden state 502 is a last convolutional feature map. In another embodiment, the convolutional neural network hidden state 502 is a selected intermediate feature map. The scalarization operator 510 may act on the convolutional neural network hidden state 502 by reducing across channels, and the squared-activation accumulation component 512 may sum squared channel values at each spatial position to produce the scalar activation-energy output 514. In such an embodiment, the selected psi field 516 may be defined per pixel or per spatial location.

The Transformer hidden state 504 may include a last hidden token state, an intermediate token representation, an attention-block output, or another token-indexed internal representation produced by a Transformer architecture. In one preferred embodiment, the Transformer hidden state 504 is the last hidden token state of a selected layer. The scalarization operator 510 may act on the Transformer hidden state 504 by reducing across embedding dimensions, and the squared-activation accumulation component 512 may sum squared embedding-dimension values for each token position. The scalar activation-energy output 514 therefore becomes a token-indexed scalar field, and the selected psi field 516 may be arranged over sequence positions or token positions.

The graph neural network hidden state 506 may include a node embedding state, graph-convolution output, message-passing state, or other node-indexed internal representation produced by a graph neural network. In one preferred embodiment, the graph neural network hidden state 506 is a node embedding layer. The scalarization operator 510 may act on the graph neural network hidden state 506 by reducing across embedding dimensions or feature channels, and the squared-activation accumulation component 512 may sum squared values for each node. The scalar activation-energy output 514 then becomes a node-indexed scalar field suitable for subsequent graph-Laplacian embodiments of the recognition-cost computation, and the selected psi field 516 may therefore be arranged over graph nodes.

The multilayer perceptron hidden state 508 may include a penultimate hidden layer, an intermediate hidden layer, or another internal vector representation of a multilayer perceptron, including a multilayer perceptron used for regression or other tabular-task prediction. In one preferred embodiment, the multilayer perceptron hidden state 508 is a penultimate hidden layer. The scalarization operator 510 may act on the multilayer perceptron hidden state 508 by reducing across hidden dimensions, and the squared-activation accumulation component 512 may sum squared hidden-dimension values to produce the scalar activation-energy output 514. Depending on embodiment, the selected psi field 516 may be defined over examples, positions within a structured input, or other discrete locations associated with the multilayer perceptron hidden state 508, and model predictions may comprise regression values or other tabular-task outputs.

The scalarization operator 510 may generally include any operation that converts an internal model representation into a scalarized field appropriate for the disclosed recognition-cost computation. In preferred embodiments, the scalarization operator 510 performs a norm-squared reduction or another sum-of-squares-based reduction. In one preferred mathematical form, psi may be computed as the sum of squared activation values across channels, embedding dimensions, or hidden dimensions of a selected internal representation, thereby forming an activation-energy quantity. In other embodiments, the scalarization operator 510 may include channel reduction, embedding-dimension reduction, projection-based scalarization, pooled scalarization, grouped scalarization, or other operations that preserve a meaningful scalar activation-energy interpretation.

The squared-activation accumulation component 512 preferably accumulates squared values because such accumulation provides a direct scalar activation-energy measure derived from the internal representation and aligns with the disclosed Recognition-Physics framing of psi as an activation-energy field. However, other scalar activation-energy formulations may be used provided that the resulting scalar activation-energy output 514 remains suitable for the disclosed psi-to-X-to-J-to-C_RP chain. In this regard, the preferred embodiments are intended to be exemplary and load-bearing, not limiting.

The scalar activation-energy output 514 represents the resulting scalar field after application of the scalarization operator 510 and the squared-activation accumulation component 512. In broad embodiments, the scalar activation-energy output 514 may be a one-dimensional sequence-indexed field, a two-dimensional spatial field, a graph-node field, a batch-indexed field, or another topology-dependent scalar field. The selected psi field 516 may then represent the scalar activation-energy field actually used in the disclosed loss computation, whether from a single selected layer or from one member of a selected layer set.

In one preferred embodiment, the selected psi field 516 is derived from a single selected layer. In another preferred embodiment, multiple candidate scalar activation-energy outputs 514 may be available from multiple layers, and a particular selected psi field 516 may be chosen according to a selected-layer configuration. Thus, FIG. 5 not only shows model-family-specific psi derivation, but also supports embodiments in which the derivation stage and the layer-selection stage interact.

The psi derivation view 500 supports a broad fallback ladder. At the broadest level, the invention includes deriving a scalar activation-energy field from an internal model representation. At a narrower level, the internal model representation may be the convolutional neural network hidden state 502, the Transformer hidden state 504, the graph neural network hidden state 506, or the multilayer perceptron hidden state 508. At a narrower level still, the scalarization operator 510 and the squared-activation accumulation component 512 may together implement a norm-squared or sum-of-squares reduction. At a still narrower level, the selected psi field 516 may be derived from a last convolutional feature map, a last hidden token state, a node embedding layer, or a penultimate hidden layer.

In one preferred implementation grouping corresponding to disclosed benchmark examples, psi is derived from a final convolutional feature map for ResNet-style image models, a last hidden token state for GPT-style sequence models, a node embedding layer for graph convolutional models, a segmentation-oriented feature map for U-Net-style models, a compact convolutional feature representation for MobileNet-style models, and an internal hidden representation for multilayer-perceptron or regression models. This grouping is consistent with the empirical validation pathways discussed later herein and provides direct support for the disclosed cross-architecture benchmark set.

The psi derivation view 500 also clarifies that the invention is not limited to one architecture family. Instead, different internal representation families may feed the same scalarization logic and produce a scalar activation-energy output 514 compatible with the same recognition-cost pipeline. Thus, the common operative structure of the invention is preserved across convolutional, sequence, graph, and fully connected models. This is important because the core invention lies not in the particular architecture, but in the disclosed loss-function structure and the use of psi as a scalar activation-energy field derived from model internals.

In some embodiments, the scalarization operator 510 may additionally include optional normalization, scaling, pooling, masking, dimensional alignment, or selection operations before or after the squared-activation accumulation component 512. For example, a subset of channels or embedding dimensions may be selected, masked, or pooled before producing the scalar activation-energy output 514. In other embodiments, the scalar activation-energy output 514 may be computed independently at multiple layers, thereby producing multiple candidate psi fields from which one or more selected psi fields 516 are chosen. Such variations do not alter the central role of psi as a scalar activation-energy field derived from an internal model representation.

Accordingly, FIG. 5 provides claim-supportive disclosure for both broad and architecture-specific psi derivation embodiments. It shows that internal model representations including 502, 504, 506, and 508 may be processed by scalarization operator 510 and squared-activation accumulation component 512 to produce scalar activation-energy output 514 and selected psi field 516. The resulting selected psi field 516 may then be used in the disclosed recognition-cost coupling term, resonance term, action-gradient penalty term, and recognition-cost computation chain described elsewhere herein.

FIG. 6 illustrates a layer-selection architecture 600 showing single-layer and multi-layer embodiments for deriving psi, computing recognition cost, applying resonance weighting, and assembling layer-based contributions to the disclosed objective. The layer-selection architecture 600 includes a first selected layer 602, a second selected layer 604, an nth selected layer 606, a per-layer psi path 608, a per-layer C_RP path 610, a per-layer resonance weighting 612, a per-layer action-gradient penalty accumulation 614, and a summed contribution 616. FIG. 6 therefore provides a detailed view of how the disclosed loss may be practiced using one selected layer or a plurality of selected layers without changing the core loss-function mechanism.

In one preferred embodiment, the first selected layer 602 is the only selected layer used for the disclosed recognition-theoretic computation. In such a single-layer embodiment, the per-layer psi path 608 derives a scalar activation-energy field psi from the first selected layer 602, the per-layer C_RP path 610 computes a recognition cost field from that psi, the per-layer resonance weighting 612 applies phi\hat{ }(−n/2) to a summed psi contribution for that layer, and the per-layer action-gradient penalty accumulation 614 computes the action-gradient penalty contribution associated with that layer. The summed contribution 616 may then be identical to the single-layer contribution because only one layer participates.

In another preferred embodiment, the layer-selection architecture 600 uses multiple selected layers, such as the first selected layer 602, the second selected layer 604, and the nth selected layer 606. In such a multi-layer embodiment, each selected layer may generate a corresponding scalar activation-energy field through the per-layer psi path 608. Each such scalar activation-energy field may then feed a corresponding recognition-cost computation through the per-layer C_RP path 610. A corresponding resonance weighting may then be applied through the per-layer resonance weighting 612 according to the layer index n or other disclosed depth-position convention, and corresponding action-gradient penalty contributions may be generated through the per-layer action-gradient penalty accumulation 614. The summed contribution 616 may then aggregate one or more of the resulting per-layer contributions into a total multi-layer contribution.

The first selected layer 602, second selected layer 604, and nth selected layer 606 may be selected in any suitable manner consistent with the disclosed framework. In some embodiments, a selected layer may be a final hidden layer. In other embodiments, a selected layer may be a penultimate hidden layer. In other embodiments, a selected layer may be one member of a predetermined layer set, an architecture-specific hidden layer, a block output, an encoder-stage output, a decoder-stage output, an attention layer, a feature-map layer, a node-update layer, or another internal representation stage. Thus, the layer-selection architecture 600 supports both narrow and broad selections of layer location while preserving the core psi-to-X-to-J-to-C_RP structure.

The per-layer psi path 608 may derive a separate psi field for each selected layer. In one preferred embodiment, the per-layer psi path 608 performs the same scalarization operation across all selected layers. In another embodiment, different scalarization operations may be used for different layers, provided that each selected layer produces a scalar activation-energy field suitable for the disclosed recognition-cost computation. For example, a convolutional feature-map layer may use channel-wise squared accumulation, while a Transformer token layer may use embedding-dimension squared accumulation, and a graph layer may use node-feature squared accumulation. In all such cases, the per-layer psi path 608 produces scalar activation-energy information that remains compatible with the disclosed recognition-cost mechanism.

The per-layer C_RP path 610 computes a recognition cost field for the psi associated with each selected layer. In one embodiment, each selected layer has a separate instance of the recognition-cost pipeline described in connection with FIG. 4. Thus, the per-layer C_RP path 610 may compute Delta_x psi, a structural ratio X, normalization by X_opt, and J-cost evaluation separately for the first selected layer 602, the second selected layer 604, and the nth selected layer 606. The resulting per-layer recognition cost fields may then be used in corresponding coupling, resonance, and action-gradient calculations.

The per-layer resonance weighting 612 applies fixed depth weighting to one or more per-layer resonance contributions. In one exact embodiment, a resonance contribution for a selected layer is given by phi\hat{ }(−n/2) sum_j psi_j for that layer. In a single-layer embodiment, the per-layer resonance weighting 612 may therefore apply phi\hat{ }(−n/2) to a single per-layer summed psi contribution. In a multi-layer embodiment, the per-layer resonance weighting 612 may apply phi\hat{ }(−n/2) or another corresponding fixed depth weighting to each selected layer separately before aggregation. The per-layer resonance weighting 612 therefore supports the disclosed phi-hierarchical depth weighting and reinforces that the resonance term is governed by fixed depth weighting rather than a tuned schedule.

In one preferred formal framing, the resonance contribution decays with depth according to the golden-ratio exponent, so that earlier selected layers contribute more strongly than deeper selected layers under the same activation-energy scale. This decay relationship is reflected in the formal-verification item resonance_weight_decays discussed later herein. The per-layer resonance weighting 612 therefore is not merely heuristic. It is a disclosed consequence of the fixed Recognition-Physics coefficient structure.

The per-layer action-gradient penalty accumulation 614 computes one or more action-gradient penalty contributions associated with selected layers. In one exact embodiment, a layer-specific action-gradient contribution is based on ∥grad_psi C_RP∥\hat{ }2 for the psi and recognition cost field associated with that layer, scaled by alpha_4. In a single-layer embodiment, the per-layer action-gradient penalty accumulation 614 may simply produce one layer-specific action-gradient contribution. In a multi-layer embodiment, the per-layer action-gradient penalty accumulation 614 may form multiple layer-specific action-gradient contributions and accumulate them for later use in the summed contribution 616 or in another aggregation path. Thus, the per-layer action-gradient penalty accumulation 614 supports both narrow single-layer action-gradient embodiments and broader multi-layer action-gradient embodiments.

The summed contribution 616 may represent one or more aggregated quantities formed from selected-layer contributions. In some embodiments, the summed contribution 616 may include only the resonance contribution aggregated across selected layers. In other embodiments, the summed contribution 616 may include aggregated resonance contributions and aggregated action-gradient penalty contributions. In other embodiments, the summed contribution 616 may be understood more generally as an aggregation point at which per-layer contributions are combined before final loss assembly. In a broad operational sense, the summed contribution 616 shows that the invention can support plural selected layers without abandoning the disclosed term structure.

In one preferred multi-layer formulation corresponding to the broader exact expression described above, the loss may be assembled by summing over selected layers n such that each selected layer contributes a coupling term proportional to psi_n, j C_RP, n(x_j), a golden-ratio resonance term proportional to phi\hat{ }(−n/2) sum_j psi_n, j, and an action-gradient term proportional to X_opt\hat{ }2 times the squared norm of the derivative of C_RP, n with respect to psi_n, j. This multi-layer form preserves explicit constant ordering and preserves the exact role of X_opt and phi across the selected layers.

The layer-selection architecture 600 therefore supports a clear fallback ladder. At a broad level, the invention includes using one or more selected layers. At a narrower level, the invention includes a single selected layer embodiment and a plurality-of-selected-layers embodiment. At a narrower level still, the selected layer may be the first selected layer 602, second selected layer 604, nth selected layer 606, a final hidden layer, a penultimate hidden layer, a predetermined layer set, or an architecture-specific layer. At a further fallback level, the invention includes per-layer psi derivation through path 608, per-layer recognition-cost computation through path 610, per-layer resonance weighting through component 612, and per-layer action-gradient penalty accumulation through component 614, with aggregation through summed contribution 616.

FIG. 6 also helps clarify the relationship between the broad operational formulation and the exact kernel. In a broad operational embodiment, the invention includes a fixed-weight depth-dependent resonance contribution formed from a summed psi quantity for a selected layer and a fixed-coefficient action-gradient penalty based on variation of C_RP with respect to psi. In a narrower operational embodiment, these may be implemented separately at multiple selected layers and then aggregated. In a still narrower embodiment, the resonance term for each selected layer is phi\hat{ }(−n/2) sum_j psi_j and the action-gradient penalty is alpha_4∥grad_psi C_RP∥\hat{ }2 for that layer. Thus, FIG. 6 provides continuity between the broad claim-support ladder and the exact mathematical fallback ladder.

The layer-selection architecture 600 additionally reinforces that the invention is not limited to shallow or single-stage models. Because the first selected layer 602, second selected layer 604, and nth selected layer 606 may correspond to different depths of a model, the invention may be used in architectures having many layers, blocks, stages, or modules. At the same time, FIG. 6 preserves the central drafting point that multi-layer use is an embodiment rather than a requirement. The core invention may still be practiced using a single selected layer and a single resulting psi field, recognition cost field, resonance contribution, and action-gradient penalty contribution.

Accordingly, FIG. 6 provides robust support for both single-layer and multi-layer embodiments, for per-layer and aggregated resonance structures, and for per-layer and aggregated action-gradient structures. The layer-selection architecture 600 shows that one or more selected layers 602, 604, and 606 may generate per-layer psi through path 608, per-layer recognition cost through path 610, per-layer resonance weighting through component 612, per-layer action-gradient penalty accumulation through component 614, and one or more aggregated results through summed contribution 616, all while preserving the disclosed recognition-theoretic loss framework.

FIG. 7 illustrates an operator-variant view 700 showing topology-specific embodiments of the disclosed Delta operator. The operator-variant view 700 includes a one-dimensional sequence operator 702, a two-dimensional image operator 704, a graph Laplacian operator 706, a corresponding psi topology 708, a corresponding Delta psi output 710, a corresponding X output 712, and a corresponding C_RP output 714. FIG. 7 therefore shows that the disclosed recognition-cost computation may be adapted to different model and data topologies while preserving the same underlying psi-to-X-to-J-to-C_RP structure.

In a one-dimensional embodiment, the one-dimensional sequence operator 702 acts on a corresponding psi topology 708 arranged over ordered positions such as sequence positions, token positions, temporal positions, or other one-dimensional ordered locations. In one preferred embodiment, the one-dimensional sequence operator 702 is a second-difference operator. For example, a local structural response may be computed from neighboring positions so that the corresponding Delta psi output 710 reflects a one-dimensional second-difference field. This one-dimensional embodiment is especially suitable for sequence models, token-based language models, time-series models, and other models in which psi is indexed along an ordered one-dimensional domain.

In a two-dimensional embodiment, the two-dimensional image operator 704 acts on a corresponding psi topology 708 arranged over image positions, spatial-array positions, grid positions, or other two-dimensional discrete locations. In one preferred embodiment, the two-dimensional image operator 704 is a discrete Laplacian. The corresponding Delta psi output 710 may therefore represent a two-dimensional structural-difference or Laplacian-response field over pixels or spatial positions. This embodiment is especially suitable for convolutional neural networks, vision transformers using spatial tokenization, segmentation models, image classifiers, image-to-image models, and other models in which psi is naturally arranged across two-dimensional positions.

In a graph embodiment, the graph Laplacian operator 706 acts on a corresponding psi topology 708 arranged over graph nodes, vertices, or other graph-structured locations. In one preferred embodiment, the graph Laplacian operator 706 is a graph Laplacian matched to the connectivity structure of the underlying graph representation. The corresponding Delta psi output 710 may therefore represent a graph-structural response field indicating local structural variation of psi relative to neighboring nodes. This embodiment is especially suitable for graph neural networks, relational learning models, network-structured data models, and other machine-learning systems in which psi is indexed over graph nodes or comparable connectivity-defined structures.

The corresponding psi topology 708 may therefore differ depending on embodiment. In a sequence embodiment, the corresponding psi topology 708 may be a one-dimensional ordered field. In an image embodiment, the corresponding psi topology 708 may be a two-dimensional spatial field. In a graph embodiment, the corresponding psi topology 708 may be a node-indexed graph field. More generally, the corresponding psi topology 708 may be any discrete topology over which a topology-matched Delta operator may act. The central requirement is that the scalar activation-energy field psi be arranged over a topology that supports the disclosed structural-ratio computation.

The corresponding Delta psi output 710 is the output of applying the topology-appropriate operator to the corresponding psi topology 708. In one embodiment, the corresponding Delta psi output 710 may be a second-difference output. In another embodiment, the corresponding Delta psi output 710 may be a discrete Laplacian output. In another embodiment, the corresponding Delta psi output 710 may be a graph Laplacian output. In all such cases, the corresponding Delta psi output 710 provides the structural-difference quantity used to compute the disclosed structural ratio X.

The corresponding X output 712 is then computed from the corresponding Delta psi output 710 and the corresponding psi topology 708. In one exact embodiment, the corresponding X output 712 is computed according to X=|Delta psi|/(psi+epsilon). Thus, the corresponding X output 712 reflects the magnitude of local structural variation normalized by the local scalar activation-energy level plus epsilon stabilization. The corresponding X output 712 is then normalized by X_opt and used in J-cost evaluation to generate the corresponding C_RP output 714.

The corresponding C_RP output 714 is the resulting recognition cost field produced after normalization of X by X_opt and evaluation of the J-cost function. In one exact embodiment, the corresponding C_RP output 714 satisfies C_RP(x)=J(X(x)/X_opt), where J(z)=0.5(z+1/z)−1. Thus, the corresponding C_RP output 714 may be a sequence-indexed recognition cost field, an image-position recognition cost field, or a graph-node recognition cost field depending on the topology. In each case, the corresponding C_RP output 714 remains a recognition cost field computed from psi through the disclosed Delta, X, and J chain.

In one preferred benchmark correspondence, the one-dimensional sequence operator 702 aligns with GPT-style language-model embodiments, the two-dimensional image operator 704 aligns with ResNet-style and U-Net-style image embodiments, and the graph Laplacian operator 706 aligns with graph convolutional embodiments such as OGB-ArXiv. Thus, FIG. 7 supports both the doctrinal topology ladder and the disclosed validation set.

The operator-variant view 700 supports a strong fallback ladder for the Delta operator. At a broad level, the invention includes applying a topology-matched discrete operator to psi. At a narrower level, the topology-matched discrete operator may be the one-dimensional sequence operator 702, the two-dimensional image operator 704, or the graph Laplacian operator 706. At a still narrower level, the one-dimensional sequence operator 702 may be a second-difference operator, the two-dimensional image operator 704 may be a discrete Laplacian, and the graph Laplacian operator 706 may be a graph Laplacian. Each such embodiment produces a corresponding Delta psi output 710, a corresponding X output 712, and a corresponding C_RP output 714.

FIG. 7 also clarifies that the invention is not limited to one kind of internal geometry. The disclosed loss-function kernel can be used with ordered sequences, spatial arrays, graph structures, and related topologies because the operative mechanism is defined at the level of psi, Delta, X, X_opt normalization, and J-cost evaluation. Thus, different architectures and tasks may feed different topological forms of psi into different operator variants without changing the core recognition-theoretic structure of the invention.

In some embodiments, the one-dimensional sequence operator 702, the two-dimensional image operator 704, or the graph Laplacian operator 706 may include implementation-specific details such as boundary handling, padding behavior, adjacency normalization, masked positions, sparse computation, or other practical variations. For example, a sequence boundary may be handled by truncation, reflection, or another boundary convention; an image operator may use a discrete neighborhood stencil; and a graph Laplacian may use a normalized or unnormalized graph operator. Such implementation details may vary while preserving the central disclosure that a topology-matched Delta operator acts on psi to produce the structural-difference quantity used in the recognition-cost computation.

The operator-variant view 700 further supports both single-layer and multi-layer embodiments. In a single-layer embodiment, one corresponding psi topology 708 may be processed through one of the operators 702, 704, or 706 to generate one corresponding Delta psi output 710, one corresponding X output 712, and one corresponding C_RP output 714. In a multi-layer embodiment, separate psi topologies from multiple selected layers may each be processed through one of the operators 702, 704, or 706, thereby generating multiple recognition cost fields that may be used in per-layer or aggregated coupling, resonance, and action-gradient structures.

Accordingly, FIG. 7 provides claim-supportive disclosure showing that the invention may be practiced across multiple topological settings. The operator-variant view 700 shows that a topology-specific operator 702, 704, or 706 may act on a corresponding psi topology 708 to produce a corresponding Delta psi output 710, a corresponding X output 712, and a corresponding C_RP output 714, thereby preserving the disclosed recognition-cost pipeline across sequence, image, and graph embodiments.

FIG. 8 illustrates a training workflow 800 showing an end-to-end sequence by which the disclosed recognition-theoretic loss may be used in machine-learning training. The training workflow 800 includes a batch receipt stage 802, a forward pass stage 804, a prediction generation stage 806, a hidden-state capture stage 808, a psi derivation stage 810, a C_RP computation stage 812, a loss assembly stage 814, a gradient computation stage 816, a parameter update stage 818, and a trained-model state 820. FIG. 8 therefore provides an operational workflow view of how the disclosed loss is used from receipt of training data through model updating.

At the batch receipt stage 802, a training batch is received. The training batch may include input examples, target labels, target values, target sequences, segmentation masks, graph annotations, or other supervisory data depending on the model and task. In some embodiments, the batch receipt stage 802 may also receive metadata relevant to topology, masking, padding, layer selection, graph structure, attention masks, adjacency information, or other model-specific information used in later stages of the workflow.

At the forward pass stage 804, the received training batch is processed through the machine-learning model. The forward pass stage 804 may include application of one or more model layers, blocks, modules, attention mechanisms, message-passing mechanisms, convolution operations, normalization layers, nonlinearities, recurrent operations, or other internal model operations. The forward pass stage 804 may produce both final outputs and internal representations used later in the disclosed recognition-theoretic computation.

At the prediction generation stage 806, predictions are generated from the model. Such predictions may include class logits, regression values, class probabilities, token predictions, segmentation maps, graph outputs, similarity scores, control values, or other outputs depending on the task. The prediction generation stage 806 supplies the prediction information used to compute the disclosed data-fit term. In this respect, the prediction generation stage 806 may be understood as generating y_hat for comparison against targets y.

At the hidden-state capture stage 808, one or more internal hidden representations are captured from the machine-learning model. The hidden-state capture stage 808 may capture a single hidden state from a selected layer or may capture multiple hidden states from multiple selected layers. Captured hidden states may include feature maps, token states, node embeddings, penultimate activations, latent states, or other internal model representations from which psi may be derived. The hidden-state capture stage 808 therefore provides the internal representation inputs needed for the recognition-theoretic portions of the loss.

At the psi derivation stage 810, a scalar activation-energy field psi is derived from one or more hidden representations captured at stage 808. In preferred embodiments, the psi derivation stage 810 applies a scalarization operator and a squared-activation accumulation process to derive psi. In other embodiments, the psi derivation stage 810 may apply channel reduction, embedding-dimension reduction, node-feature reduction, pooling, projection-based scalarization, or other scalar activation-energy derivation operations. The output of the psi derivation stage 810 may be a single selected psi field or multiple layer-specific psi fields depending on embodiment.

At the C_RP computation stage 812, the recognition cost field C_RP is computed from psi. In one exact embodiment, the C_RP computation stage 812 computes Delta_x psi, computes X=|Delta_x psi|/(psi+epsilon), normalizes by X_opt, and evaluates J(z)=0.5(z+1 /z)−1 on X/X_opt to generate C_RP. The C_RP computation stage 812 may operate using a topology-matched Delta operator, including a one-dimensional second-difference operator, a two-dimensional Laplacian, or a graph Laplacian. In some embodiments, the C_RP computation stage 812 may be repeated for multiple selected layers to generate multiple layer-specific recognition cost fields.

At the loss assembly stage 814, the operative terms of the disclosed loss are assembled. In one load-bearing embodiment, the loss assembly stage 814 computes a data-fit term, a recognition-cost coupling term, a phi-depth resonance term, and an action-gradient penalty term. In one exact embodiment, the loss assembly stage 814 computes exactly four operative terms according to:

L_RT=L_data+alpha_2<psi, C_RP>+phi\hat{ }(−n/2) sum_j psi_j+alpha_4∥grad_psi C_RP∥\hat{ }2

In broader embodiments, the loss assembly stage 814 may include per-layer coupling contributions, per-layer resonance contributions, per-layer action-gradient contributions, or aggregated multi-layer contributions, provided that the disclosed coupling, resonance, and action-gradient structure is preserved. The loss assembly stage 814 may also apply the fixed coefficient relationships alpha_2=X_opt=phi/pi, alpha_4=X_opt\hat{ }2, and phi\hat{ }(−n/2) weighting.

In a preferred multi-layer embodiment, the loss assembly stage 814 preserves the explicit ordering of data-fit term first, recognition-cost coupling second, phi-depth resonance third, and action-gradient penalty fourth.

At the gradient computation stage 816, gradients are computed from the resulting total loss. In one embodiment, gradients with respect to psi may be computed for formation of the action-gradient penalty and gradients with respect to model parameters may be computed for parameter updating. In software embodiments, the gradient computation stage 816 may be carried out by an autodiff engine, gradient tape, or differentiable programming framework. In some embodiments, higher-order gradient construction may be used to preserve the action-gradient path through C_RP. The gradient computation stage 816 may therefore include both ordinary parameter-gradient computation and the specialized gradient path associated with the disclosed action-gradient penalty.

At the parameter update stage 818, model parameters are updated based on the gradients computed at stage 816. The parameter update stage 818 may be performed using any suitable optimizer, including stochastic gradient descent, Adam, AdamW, RMSProp, momentum-based optimization, adaptive optimization, or other gradient-based update methods. In some embodiments, the parameter update stage 818 may further involve clipping, normalization, scheduling, mixed-precision handling, distributed gradient synchronization, or other training-support operations. Such update-related choices may vary without altering the central role of the disclosed recognition-theoretic loss. In disclosed benchmark examples, the loss is designed to function as a drop-in replacement for the baseline loss while preserving the rest of the training loop, including optimizer and schedule, except where specific experiments expressly state otherwise.

The trained-model state 820 represents the resulting model state after one or more parameter updates. In a single training-step embodiment, the trained-model state 820 may represent an updated parameter state after one batch. In a multi-step or full-training embodiment, the trained-model state 820 may represent a partially trained or fully trained model resulting from repeated performance of the workflow 800. The trained-model state 820 may then be used for inference, further training, fine-tuning, validation, benchmarking, deployment, or other downstream use.

The training workflow 800 may also be described in terms of inputs, intermediate products, and outputs. Inputs may include a training batch, targets, hidden representations, selected layer information, epsilon, and topology information used for Delta_x. Intermediate products may include predictions, captured hidden states, psi, Delta psi, X, normalized X/X_opt, C_RP, per-term loss values, total L_RT, gradients with respect to psi, and gradients with respect to model parameters. Outputs may include updated model parameters, a trained-model state 820, and optional diagnostics such as convergence curves, term magnitudes, structural visualizations, and runtime-overhead outputs.

In one broad operational embodiment, the training workflow 800 includes receiving a batch at stage 802, performing a forward pass at stage 804, generating predictions at stage 806, capturing hidden states at stage 808, deriving psi at stage 810, computing C_RP at stage 812, assembling the loss at stage 814, computing gradients at stage 816, and updating parameters at stage 818 to produce the trained-model state 820. In one exact embodiment, the operative loss terms assembled at stage 814 are exactly four and include the data-fit term, the recognition-cost coupling term, the phi-depth resonance term, and the action-gradient penalty term.

The training workflow 800 also clarifies that the invention may be used within otherwise conventional training loops. That is, the batch receipt stage 802, forward pass stage 804, prediction generation stage 806, gradient computation stage 816, and parameter update stage 818 may correspond generally to standard machine-learning training-loop stages. What changes is the structure of the loss assembled at stage 814 and the use of hidden-state-derived psi and recognition cost field C_RP. The invention therefore integrates into existing training practice while supplying a different and more structured training objective.

In some embodiments, the workflow 800 may be repeated across epochs, data shards, distributed workers, curriculum stages, validation intervals, fine-tuning stages, or task-transfer stages. In other embodiments, one or more stages may be modified according to task or platform. For example, hidden-state capture stage 808 may capture one layer or multiple layers, psi derivation stage 810 may use different scalarization paths, C_RP computation stage 812 may use different Delta variants, and parameter update stage 818 may use different optimizers or scheduling choices. Such variations do not change the disclosed end-to-end role of the recognition-theoretic loss within the training workflow 800.

In disclosed validation examples corresponding to the workflow 800, the loss was applied to ResNet-18 on CIFAR-10, GPT-2 fine-tuning on Penn Treebank, graph convolutional training on OGB-ArXiv, U-Net on BraTS, and quantized MobileNet-v2 on an edge neural-processing environment. In such examples, the workflow preserved the standard forward-pass and update structure while substituting the disclosed loss at the loss assembly stage 814. This is significant because the practical deployment of the invention does not require redesign of the surrounding training framework.

Accordingly, FIG. 8 provides a full operational map from batch receipt 802 through trained-model state 820. It shows how the disclosed loss is incorporated into an end-to-end training process and supports method claims reciting receipt of input data, generation of predictions and hidden representations, derivation of psi, computation of C_RP, assembly of the disclosed operative terms, gradient computation, and model-parameter updating.

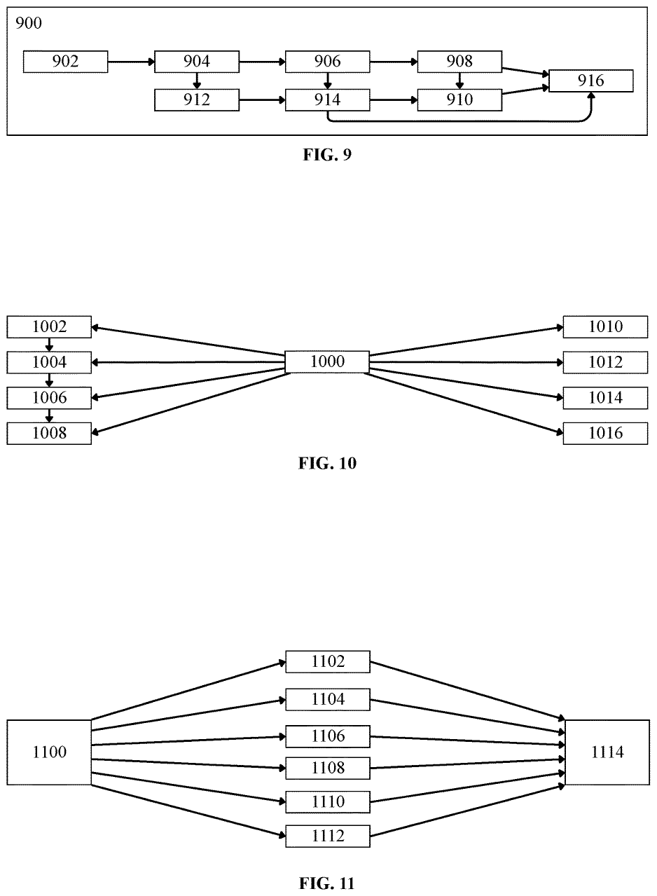

FIG. 9 illustrates an implementation environment 900 showing software and optional hardware embodiments for practicing the disclosed recognition-theoretic loss. The implementation environment 900 includes a software framework layer 902, a loss-function library 904, an autodiff engine 906, an optional accelerator interface 908, an optional hardware loss unit 910, an arithmetic-expansion path 912, an update return path 914, and a deployment target 916. FIG. 9 therefore shows how the disclosed loss-function mechanism may be embodied in software-only, software-plus-autodiff, and optional hardware-assisted forms while keeping the core invention centered on the loss-function structure itself.

The software framework layer 902 may include any machine-learning software framework or execution environment capable of performing forward computation, differentiable computation, gradient-based training, or model parameter updating. In preferred embodiments, the software framework layer 902 includes PyTorch, TensorFlow, and JAX. The software framework layer 902 may provide model execution, tensor operations, batching, optimizer integration, distributed training utilities, mixed-precision support, memory management, and related training infrastructure.

The loss-function library 904 may implement the disclosed recognition-theoretic loss as a reusable software module, library component, callable function set, class, package, or other software artifact. In one embodiment, the loss-function library 904 defines constants including phi, X_opt, and epsilon. In one preferred embodiment, phi is defined as the golden ratio, X_opt is defined as phi divided by pi, and epsilon is defined as a small positive stabilizing constant. In one preferred numeric form, X_opt is approximately 0.5149 and X_opt squared is approximately 0.2651.

In one preferred implementation, the loss-function library 904 defines a j_cost function implementing J(z)=0.5(z+1/z)−1. The loss-function library 904 further defines a compute_c_rp function that computes Delta_x psi, stabilized normalization, X, normalization by X_opt, and a resulting recognition cost field C_RP. The loss-function library 904 further defines a loss_rt function that computes a data-fit term, a recognition-cost coupling term, a phi-depth resonance term, and an action-gradient penalty term and combines those terms into the disclosed total loss, with the data-fit term, activation-energy derivation, recognition-cost computation, recognition-cost coupling, golden-ratio resonance, and action-gradient penalty implemented as differentiable tensor operations within an automatic-differentiation framework.

In one preferred PyTorch embodiment, the implementation may be expressed in a form corresponding to:

phi=(1+sqrt(5))/2, X_opt=phi/pi, alpha_2=X_opt, and alpha_4=X_opt**2

A preferred PyTorch-style j_cost implementation may return 0.5 times (z+1.0/z) minus 1.0. A preferred compute_c_rp implementation may compute a discrete derivative or Laplacian of psi, compute X as the absolute value of Delta_x psi divided by psi plus epsilon, normalize X by X_opt, and return J of the normalized value. A preferred loss_rt implementation may compute the data-fit term, compute C_RP, compute a coupling term alpha_2 times the sum or inner product of psi and C_RP, compute a resonance term phi\hat{ }(−n/2) times the summed psi quantity for the selected layer, compute an action-gradient term alpha_4 times the squared norm of the gradient of C_RP with respect to psi, and combine these into the total loss.

The autodiff engine 906 may be part of the software framework layer 902 or may operate as a distinct logical component within the implementation environment 900. The autodiff engine 906 may compute gradients of the total loss with respect to model parameters and may also compute gradients of C_RP with respect to psi for use in the action-gradient penalty term. In one PyTorch embodiment, the autodiff engine 906 may use automatic differentiation and create_graph behavior where higher-order gradient construction is used to preserve the action-gradient path. In one such embodiment, grad(C_RP.sum( ), psi, create_graph=True) may be used to obtain the relevant gradient path.

In one preferred TensorFlow embodiment, the loss-function library 904 defines the same fixed constants, a j_cost function implementing the same exact J expression, a compute_c_rp function computing Delta_x psi, X, normalization, and C_RP, and a loss_rt function assembling the four-term loss. In one such embodiment, a GradientTape watches psi, computes C_RP, and obtains a gradient used in the action-gradient penalty term. The resulting total loss may then be used in a standard TensorFlow training loop without altering the larger workflow.

In one preferred JAX embodiment, the loss-function library 904 again defines the same fixed constants and the same exact J-cost structure. A compute_c_rp function computes Delta_x psi, stabilized normalization, X, and C_RP. A loss_rt function computes the disclosed operative terms. In one such embodiment, a gradient operator is applied to a summed or aggregated C_RP computation to obtain the gradient path used in the action-gradient penalty term. Thus, the disclosed implementation is portable across multiple autodiff-capable environments while preserving the same exact kernel and fixed coefficient structure.

The optional accelerator interface 908 may provide communication or computational integration between software-executed loss logic and one or more hardware-accelerated resources. In some embodiments, the optional accelerator interface 908 may couple the software framework layer 902 or loss-function library 904 to a graphics processing unit, tensor processor, neural processing unit, field-programmable gate array, application-specific integrated circuit, or other compute accelerator. In some embodiments, the optional accelerator interface 908 may be used only for ordinary tensor computation and gradient propagation. In other embodiments, the optional accelerator interface 908 may additionally support specialized implementation of one or more disclosed recognition-theoretic computations.

The optional hardware loss unit 910 may implement one or more portions of the disclosed loss-function mechanism in hardware. In one optional embodiment, the optional hardware loss unit 910 is configured to compute a recognition-cost coupling term. In another optional embodiment, the optional hardware loss unit 910 is configured to compute a golden-ratio resonance term. In another optional embodiment, the optional hardware loss unit 910 is configured to compute an action-gradient penalty term. In another optional embodiment, the optional hardware loss unit 910 is configured to compute selected combinations of those terms or intermediate computations used by those terms. The optional hardware loss unit 910 may therefore support hardware-assisted execution of the disclosed loss while remaining subordinate to the principal mechanism defined by the loss-function kernel.

In hardware-assisted embodiments, the hardware accelerator need not compute an entire training gradient or implement a complete automatic-differentiation engine. The accelerator may compute one or more arithmetic portions of the disclosed loss, including Delta_x psi computation, stabilized X computation, X/X_opt normalization, J-cost evaluation, psi-C_RP products, resonance summations, squared-gradient inputs received from an automatic-differentiation engine, or intermediate tensors used to form one or more of the disclosed terms. In other embodiments, the accelerator cooperates with software automatic differentiation by returning intermediate tensors, partial derivatives, or arithmetic results used by the software framework to form the action-gradient penalty and the total loss.

The arithmetic-expansion path 912 may represent a computation path by which the disclosed recognition-theoretic operations are expanded into arithmetic operations suitable for execution in software or hardware. For example, the arithmetic-expansion path 912 may include tensor arithmetic for Delta_x psi computation, absolute value operations, denominator stabilization, normalization by X_opt, J-cost evaluation, inner-product computation, summation across positions, gradient-based operations, or other arithmetic or tensor operations associated with the disclosed loss. In optional hardware-assisted embodiments, the arithmetic-expansion path 912 may map such operations into arithmetic units, pipelines, fused operations, vector units, matrix units, or other hardware-executable forms.

The update return path 914 may represent the path by which gradients, loss values, or related optimization signals are returned for parameter updating. In a software-only embodiment, the update return path 914 may carry gradients from the autodiff engine 906 into one or more optimizer routines within the software framework layer 902. In a hardware-assisted embodiment, the update return path 914 may carry values from the optional hardware loss unit 910 or the optional accelerator interface 908 back into software-driven optimization logic or into hardware-supported update logic. The update return path 914 therefore completes the training loop connection between loss computation and parameter update.

The deployment target 916 may represent a resulting executable training environment, trained-model environment, or downstream deployment environment associated with the implementation environment 900. In some embodiments, the deployment target 916 may be a software training environment. In other embodiments, the deployment target 916 may be a fine-tuning environment, validation environment, benchmarking environment, edge deployment environment, cloud environment, or another downstream use environment. The deployment target 916 is shown to indicate that the disclosed loss may be embodied in software products, training systems, and optional hardware-assisted platforms without altering the core identity of the invention.

The implementation environment 900 supports a broad fallback ladder for product and system embodiments. At a broad level, the invention may be embodied as software instructions executed within the software framework layer 902 using the loss-function library 904 and autodiff engine 906. At a narrower level, the invention may be embodied as a system including a data-fit loss module, an activation-energy derivation module, a recognition-cost computation module, a recognition-cost coupling module, a golden-ratio resonance module, an action-gradient penalty module, and a gradient-computation and parameter-update module, implemented within or across the software framework layer 902, loss-function library 904, and autodiff engine 906. At another level, the invention may be embodied as a non-transitory computer-readable medium storing instructions for carrying out the disclosed method. At a further level, the invention may be embodied in optional hardware-supported forms involving the optional accelerator interface 908 and optional hardware loss unit 910.

In one software-only embodiment, the implementation environment 900 includes the software framework layer 902, the loss-function library 904, and the autodiff engine 906, with no specialized hardware loss unit. In one software-plus-autodiff embodiment, the loss-function library 904 is integrated tightly with the autodiff engine 906 so that gradients of both the total loss and the recognition-cost-related internal quantities are computed automatically. In one optional accelerator-supported embodiment, the software framework layer 902 and loss-function library 904 execute in conjunction with the optional accelerator interface 908. In one further optional embodiment, one or more recognition-theoretic computations are delegated to the optional hardware loss unit 910. Each such embodiment preserves the same core loss-function structure.

The implementation environment 900 also clarifies that package-distribution details, framework bindings, and deployment arrangements are downstream or implementation-specific considerations rather than the definition of the invention. The core invention is not the mere existence of a software package or a hardware device, but rather the recognition-theoretic loss structure implemented through psi derivation, recognition-cost computation, fixed coefficient relationships, resonance weighting, and action-gradient penalty logic. Accordingly, hardware and software packaging remain subordinate to the disclosed loss-function mechanism.

A non-transitory computer-readable medium embodiment may store instructions that, when executed by one or more processors, cause performance of the disclosed method of claim 1. Such instructions may cause receipt of model outputs, targets, and internal representations, derivation of psi, computation of C_RP through Delta_x, X, X_opt normalization, and J-cost evaluation, computation of a data-fit term, recognition-cost coupling term, golden-ratio resonance term, and action-gradient penalty term, assembly of the total loss, computation of gradients, and updating of model parameters. The non-transitory computer-readable medium embodiment may therefore provide a strong product-style fallback independent of whether the implementation is software-only or software-plus-hardware.

Accordingly, FIG. 9 provides claim-supportive disclosure for software embodiments, system embodiments, non-transitory medium embodiments, and optional hardware-assisted embodiments. The implementation environment 900 shows that the software framework layer 902, loss-function library 904, autodiff engine 906, optional accelerator interface 908, optional hardware loss unit 910, arithmetic-expansion path 912, update return path 914, and deployment target 916 may cooperate to implement the disclosed loss while leaving the core invention centered on the recognition-theoretic training objective itself.

FIG. 10 illustrates a validation view 1000 showing demonstrated validation outputs associated with disclosed implementations of the recognition-theoretic loss. The validation view 1000 includes a baseline benchmark output 1002, a disclosed-loss benchmark output 1004, a convergence comparison 1006, a final-metric comparison 1008, a selected structural visualization 1010, a hyperparameter-elimination comparison 1012, a runtime-overhead output 1014, and an illustrative benchmark panel 1016. FIG. 10 therefore provides a figure-level organization for empirical and quasi-empirical support associated with the disclosed loss-function kernel while keeping the invention centered on the mechanism itself rather than on any single benchmark result.

The baseline benchmark output 1002 may represent performance obtained using one or more conventional losses, including mean squared error, cross-entropy, combined Dice-plus-cross-entropy loss, focal loss, or other baseline objectives depending on the task. The disclosed-loss benchmark output 1004 may represent performance obtained using the disclosed recognition-theoretic loss. In some embodiments, the baseline benchmark output 1002 and disclosed-loss benchmark output 1004 may be shown for the same model architecture and dataset so that the effect of substituting the disclosed loss is more readily observed.

The convergence comparison 1006 may represent a comparison of training progress over epochs, steps, frames, updates, or other training intervals. In one demonstrated embodiment, the convergence comparison 1006 corresponds to a ResNet-18 model trained on CIFAR-10, where the disclosed loss reached 92 percent validation accuracy in 78 epochs as compared with 110 epochs for a mean-squared-error baseline. In the same disclosed example, the final accuracy reached 94.5 percent as compared with 93.8 percent for the baseline. In another demonstrated embodiment, the convergence comparison 1006 corresponds to GPT-2 fine-tuning on Penn Treebank, where perplexity reached 59.1 after 35 epochs as compared with 65.3 after 50 epochs for a cross-entropy baseline. In another demonstrated embodiment, the convergence comparison 1006 corresponds to a graph convolutional network on OGB-ArXiv, where the disclosed loss reached 72.8 percent accuracy as compared with 71.4 percent for a cross-entropy baseline. These disclosed comparisons illustrate that the recognition-theoretic loss can improve convergence behavior while preserving the surrounding training workflow.

The final-metric comparison 1008 may represent a comparison of final or endpoint task metrics after training. Depending on embodiment, such metrics may include classification accuracy, perplexity, graph classification accuracy, segmentation quality, Dice score, loss value, score attainment, reward, or other task-dependent metrics. In a further demonstrated embodiment, a U-Net model trained on BraTS produced a Dice score of 0.891 as compared with 0.879 for a Dice-plus-cross-entropy baseline. In another demonstrated embodiment, the graph-learning and image-learning examples likewise showed improved final metrics under the disclosed loss. The final-metric comparison 1008 therefore provides support for task-result comparisons without redefining the invention as any particular numerical outcome.

The selected structural visualization 1010 may represent one or more visual or structural diagnostics associated with learned representations or learned filters. In certain disclosed examples, the selected structural visualization 1010 may show self-similar structure, including receptive-field or filter-spacing relationships approximately matching 1: phi: phi\hat{ }2 in disclosed visualization settings. The selected structural visualization 1010 is useful as an illustrative structural diagnostic and supports the disclosed notion that the loss promotes balanced internal structure rather than arbitrary weight decay. However, such structural visualization remains illustrative and is not required for practice of the invention.

The hyperparameter-elimination comparison 1012 may represent a comparison showing that one or more baseline objectives require coefficient selection, search, or heuristic weighting, whereas the disclosed recognition-theoretic loss uses fixed coefficient relationships rather than tuned loss-term weights. In one embodiment, the hyperparameter-elimination comparison 1012 may show that baseline objectives rely on selected lambda, gamma, alpha, epsilon, or comparable weighting values while the disclosed loss uses alpha_2=X_opt=phi/pi, alpha_4=X_opt\hat{ }2, and phi\hat{ }(−n/2) depth weighting without tuning of loss-term weights. The hyperparameter-elimination comparison 1012 therefore provides support for the drafting point that the invention avoids arbitrary loss-weight search.

The runtime-overhead output 1014 may represent a comparison of runtime cost, arithmetic cost, wall-clock overhead, or other computational burden associated with using the disclosed loss relative to a baseline loss. In some embodiments, the runtime-overhead output 1014 may indicate low runtime overhead, including disclosed examples in which software overhead was measured at less than 3 percent. In optional hardware-oriented embodiments, the runtime-overhead output 1014 may also include arithmetic expansion or fused-operation comparisons relevant to accelerator-supported use. In one demonstrated edge-oriented embodiment corresponding to quantized MobileNet-v2 on an edge neural-processing environment, the disclosed implementation incurred approximately 0.8 percent area overhead and approximately 0.3 milliwatts of additional power. The runtime-overhead output 1014 should be understood as supporting optional implementation advantages rather than redefining the invention in terms of a particular overhead threshold.

The illustrative benchmark panel 1016 may combine one or more example benchmark summaries, target thresholds, validation pathways, or compact multi-example visual summaries. In one embodiment, the illustrative benchmark panel 1016 summarizes demonstrated examples including ResNet-18 on CIFAR-10, GPT-2 on Penn Treebank, graph convolutional training on OGB-ArXiv, U-Net on BraTS, and quantized MobileNet-v2 on an edge neural-processing environment. In another embodiment, the illustrative benchmark panel 1016 may summarize disclosed validation targets such as 92 percent accuracy in approximately 80 or fewer epochs for ResNet-18 on CIFAR-10, perplexity of approximately 60 or less for GPT-2 on Penn Treebank, receptive-field ratios approximately matching 1: phi: phi\hat{ }2 in selected structural visualizations, and low runtime overhead in software and optional hardware settings.

A first demonstrated example may include a ResNet-18 model trained on CIFAR-10. In such an example, a baseline loss such as mean squared error or cross-entropy may be compared with the disclosed recognition-theoretic loss. Psi may be derived from a convolutional hidden representation, such as a last convolutional feature map or another selected convolutional layer, using squared channel accumulation or another scalarization operation, and model predictions may comprise class logits or other image-task outputs. One or more selected layers may be used. Reported outputs may include epoch-to-target-accuracy comparisons, final accuracy comparisons, and structural observations showing golden-ratio-like receptive-field scaling. This example supports convolutional embodiments, image-topology Delta embodiments, and disclosed convergence and metric comparisons.

A second demonstrated example may include GPT-2 fine-tuning on Penn Treebank. In such an example, Psi may be derived from a last hidden token state or another selected Transformer hidden representation using squared embedding-dimension accumulation or another scalarization operation, and model predictions may comprise token predictions. A one-dimensional sequence or token-based Delta variant may be used, including a one-dimensional second-difference operator over token positions. A baseline such as cross-entropy may be replaced with the disclosed recognition-theoretic loss. Reported outputs may include perplexity comparison, epoch comparison, and no-tuning positioning based on fixed coefficient relationships. This example supports sequence-topology Delta embodiments, Transformer psi derivation embodiments, and language-model embodiments of the disclosed loss.

A third demonstrated example may include a graph convolutional network trained on OGB-ArXiv. In such an example, psi may be derived from node embeddings or other graph-layer internal states, model predictions may comprise graph predictions, and the discrete operator Delta may comprise a graph Laplacian over graph nodes in the recognition-cost computation. Baseline and disclosed-loss outputs may be compared in terms of graph-task metric and convergence behavior. This example supports graph-topology Delta embodiments, node-based psi derivation embodiments, and graph-learning use of the disclosed loss.

Additional demonstrated embodiments may include a U-Net model on BraTS in which model predictions comprise segmentation outputs, and a quantized MobileNet-v2 model on an edge neural-processing environment in which gradients of the disclosed total loss are used to update model parameters of the quantized or partially quantized model during quantization-aware training. In the U-Net embodiment, the selected structural visualization 1010 or final-metric comparison 1008 may include segmentation-related performance outputs such as Dice-like metrics, psi may be derived from a segmentation-oriented feature map, and the discrete operator Delta may comprise a two-dimensional Laplacian over spatial positions. In the quantized MobileNet-v2 embodiment, the runtime-overhead output 1014 or illustrative benchmark panel 1016 may include hardware-oriented observations relevant to quantized or edge-supported execution, psi may be derived from a compact convolutional feature representation, and model predictions may comprise class logits or other image-task outputs. These additional demonstrated embodiments remain supportive examples rather than the central identity of the invention.

The validation view 1000 also supports a distinction between demonstrated material and illustrative validation pathways. Demonstrated material may include the exact four-term objective, fixed coefficients alpha_2 and alpha_4, C_RP minimum at X=X_opt, action-gradient semantics with respect to psi, resonance-weight decay, and the principal empirical examples discussed above. Illustrative validation pathways may include additional benchmark targets, learning-rate robustness studies, structural-diagnostic studies, overhead studies, or other validation activities used to further test the disclosed loss. Such validation pathways are useful for showing practical evaluation routes, but they are not claim elements and should not be understood as guarantees.

The benchmark results, validation outputs, convergence values, final metrics, structural visualizations, runtime-overhead values, area-overhead values, and power values disclosed herein are non-limiting examples associated with particular model, dataset, implementation, and training configurations. They illustrate practical operation of the disclosed loss but are not required for infringement and do not define the invention. The invention is practiced when the disclosed loss structure is computed and used to update model parameters, regardless of whether a particular benchmark threshold, convergence improvement, final accuracy, perplexity value, Dice score, area overhead, or power value is achieved.

In some embodiments, the validation view 1000 may be generated automatically during training or post-training analysis. For example, convergence comparison 1006 may be generated from logged training data, final-metric comparison 1008 may be generated from evaluation scripts, selected structural visualization 1010 may be generated from hidden-state or filter analyses, hyperparameter-elimination comparison 1012 may be generated from experiment-configuration records, and runtime-overhead output 1014 may be generated from profiling or benchmark instrumentation. The validation view 1000 therefore also supports optional diagnostic and reporting outputs that may accompany use of the disclosed loss.

Accordingly, FIG. 10 provides a figure-level framework for demonstrated validation outputs associated with the invention. The validation view 1000 shows that baseline benchmark output 1002, disclosed-loss benchmark output 1004, convergence comparison 1006, final-metric comparison 1008, selected structural visualization 1010, hyperparameter-elimination comparison 1012, runtime-overhead output 1014, and illustrative benchmark panel 1016 may be used to present empirical support, practical comparisons, and validation pathways for the disclosed recognition-theoretic loss, while leaving the invention defined by the loss-function mechanism itself.

FIG. 11 illustrates a verification map 1100 showing formal-verification anchors and their relationship to claim-support structure for the disclosed recognition-theoretic loss. The verification map 1100 includes an exact four-term proof 1102, a coefficient-fixity proof 1104, an X_opt minimum proof 1106, an action-gradient proof 1108, a resonance-decay proof 1110, an overhead proof 1112, and a claim-support linkage 1114. FIG. 11 therefore provides a structured view of how machine-checked formal support may reinforce the mathematical and operational disclosure of the invention.

The exact four-term proof 1102 corresponds to formal verification that the disclosed objective comprises exactly four operative terms. In one embodiment, the exact four-term proof 1102 supports the exact-kernel formulation in which the total loss is L_RT=L_data+alpha_2 SUM_j (psi_j*C_RP, j)+phi\hat{ }(−n/2) sum_j psi_j+alpha_4 SUM_j (dC_RP, j/dpsi_j)\hat{ }2. The exact four-term proof 1102 is especially useful as support for narrower fallback language reciting exact term count and exact kernel structure.

The coefficient-fixity proof 1104 corresponds to formal verification that the operative coefficients are fixed according to the disclosed framework. In one embodiment, the coefficient-fixity proof 1104 supports alpha_2=phi/pi and alpha_4=(phi/pi)\hat{ }2. In another embodiment, the coefficient-fixity proof 1104 supports that the relevant coefficient relationships are fixed rather than selected by tuning. The coefficient-fixity proof 1104 therefore reinforces the drafting position that the invention uses fixed coefficient relationships rather than tuned loss-term weights.

The X_opt minimum proof 1106 corresponds to formal verification that the recognition cost is minimized when X=X_opt. In one embodiment, the X_opt minimum proof 1106 supports the proposition that C_RP is minimized when the structural ratio X matches the disclosed optimum structural ratio. The X_opt minimum proof 1106 therefore reinforces the mathematical kernel of the recognition-cost pipeline and supports fallback claim language reciting C_RP minimum at X=X_opt.

The action-gradient proof 1108 corresponds to formal verification that the action-gradient penalty is taken with respect to psi. In one embodiment, the action-gradient proof 1108 supports the proposition that the relevant gradient preserves an action-gradient path through C_RP with respect to psi, rather than a different gradient taken with respect to another quantity. The action-gradient proof 1108 therefore reinforces the claim-supportive meaning of the action-gradient penalty and supports claim language reciting preservation of an action-gradient path through C_RP with respect to psi.

The resonance-decay proof 1110 corresponds to formal verification that the resonance weighting decays with depth. In one embodiment, the resonance-decay proof 1110 supports the phi\hat{ }(−n/2) depth-weighting ladder, thereby reinforcing that deeper layers receive fixed depth weighting determined according to the disclosed resonance structure. The resonance-decay proof 1110 is useful for supporting both exact resonance language and broader fallback language reciting fixed-weight depth-dependent resonance contributions.

The overhead proof 1112 corresponds to formal verification of a bounded-overhead result associated with the disclosed loss. In one embodiment, the overhead proof 1112 supports the proposition that the disclosed loss can be implemented with bounded or relatively small overhead in at least certain software or implementation contexts. The overhead proof 1112 is supportive of implementation efficiency discussion, but remains subordinate to the central mechanism of the invention.

The claim-support linkage 1114 represents a structured relationship between the formal-verification items and one or more fallback layers of claim scope. For example, the exact four-term proof 1102 and coefficient-fixity proof 1104 most strongly support narrower fallback language reciting exact term count and exact coefficient identities. The X_opt minimum proof 1106 supports fallback language reciting the recognition-cost minimum relationship. The action-gradient proof 1108 supports fallback language reciting preservation of an action-gradient path through C_RP with respect to psi. The resonance-decay proof 1110 supports fallback language reciting fixed depth weighting or phi-hierarchical depth weighting. Thus, the claim-support linkage 1114 helps show how formal verification reinforces drafting support at multiple fallback layers.

In one embodiment, the formal-verification items represented in FIG. 11 are implemented in Lean. In one preferred embodiment, the formally supported items include four_term_objective, resonance_weight_decays, j_cost_minimum, coefficients_fixed, action_gradient_state, overhead_small, and phi_identity. These formal items may be described as machine-checked support layers that reinforce the structural and mathematical disclosure of the loss-function kernel. Such machine-checked support does not replace the written disclosure, but strengthens and clarifies it.

FIG. 11 also supports the distinction between central and subordinate material. The exact four-term proof 1102, coefficient-fixity proof 1104, X_opt minimum proof 1106, and action-gradient proof 1108 are especially important because they reinforce core aspects of the loss-function kernel. The resonance-decay proof 1110 is important because it supports the depth-weighting ladder. The overhead proof 1112 is supportive, but less central than the term structure and coefficient structure. This distinction is useful for preserving the core invention while still disclosing supporting implementation-oriented material.

The invention may further be described with reference to demonstrated examples and alternative embodiments in a manner that preserves claim scope. Demonstrated examples may include a ResNet-18 embodiment on CIFAR-10, a GPT-2 embodiment on Penn Treebank, a graph convolutional embodiment on OGB-ArXiv, a U-Net embodiment on BraTS, and a quantized MobileNet-v2 embodiment on an edge neural-processing environment. These examples illustrate disclosed implementations of the loss and do not limit claim scope. The empirical outputs discussed in connection with such examples, including convergence behavior, final metrics, structural visualizations, and runtime observations, are illustrative of demonstrated practice rather than definitions of the invention.

Alternative embodiments may include a classification variant in which the data-fit term is cross-entropy, a regression variant in which the data-fit term is mean squared error, a generative-adversarial-network discriminator variant, a contrastive-learning variant, a federated-learning variant, a quantization-aware variant, and an instruction-extension variant. Some such embodiments may be preferred, some may be optional, some may be prophetic, and some may be downstream. The role of such embodiments in this specification is to preserve scope and disclose different implementation paths, not to redefine the core invention away from the disclosed loss-function kernel.

In preferred embodiments, the classification variant uses cross-entropy as L_data while preserving the disclosed coupling, resonance, and action-gradient structure, and psi is derived from an internal hidden representation of the classification model while the disclosed recognition cost is computed from that hidden representation through the Delta-to-X-to-J pipeline. In preferred embodiments, a regression variant uses mean squared error as L_data while preserving the disclosed coupling, resonance, and action-gradient structure, model predictions may comprise regression values, and psi is derived from an internal hidden representation of the regression model while the disclosed recognition cost is computed from that hidden representation through the Delta-to-X-to-J pipeline. In prophetic embodiments, a discriminator of a generative-adversarial system may be trained using the disclosed loss so that internal discriminator representations are regularized by the recognition-cost structure, with psi derived from an internal discriminator representation and C_RP computed from that representation through the Delta-to-X-to-J pipeline. In prophetic embodiments, a contrastive-learning system may use psi derived from paired or batched hidden representations, with the disclosed recognition-cost structure applied to internal representation states through computation of C_RP from the hidden representations using the Delta-to-X-to-J pipeline. In optional embodiments, a federated-learning system may apply the disclosed loss locally at participating nodes without changing the fixed coefficient relationships, such that each participating node computes a local total loss from local predictions, local targets, local scalar activation-energy fields, local recognition cost fields, and corresponding gradients, and resulting updates are aggregated across the participating nodes. In optional embodiments, a quantization-aware training system may use the disclosed loss during training of quantized or partially quantized models, such that gradients of the disclosed total loss with respect to model parameters of the quantized or partially quantized model are used to update the model parameters of the quantized or partially quantized model during quantization-aware training. In downstream embodiments, instruction-set or accelerator support may be added as a platform feature without changing the core loss-function mechanism.

The invention may also be described in terms of what remains central despite implementation variation. L_data may vary while preserving the disclosed coupling, resonance, and action-gradient structure. Psi may be derived from different internal representations. Delta_x may vary according to data topology. One or more selected layers may be used. Per-layer contributions may be aggregated. Such variations do not redefine the core invention.

Accordingly, the central invention remains a machine-learning training objective in which a data-fit loss is combined with a recognition-cost coupling term, a phi-depth resonance term, and an action-gradient penalty term, where psi is derived from an internal model representation, C_RP is computed from psi through the disclosed X-and-J pipeline, coefficient relationships are fixed rather than tuned, and model parameters are updated using gradients of the resulting total loss. Downstream applications, software packaging, hardware packaging, task-specific adaptations, and implementation-specific choices are examples of use rather than the definition of the invention itself.

The foregoing Detailed Description is presented for purposes of illustration and description and is not intended to be exhaustive or to limit the invention to the precise forms disclosed. Numerous modifications, adaptations, and variations are possible in light of the above disclosure. The described embodiments were chosen and described to explain principles of the invention and practical applications thereof and to enable others skilled in the art to understand and practice the invention in various embodiments and with various modifications suited to the particular use contemplated. It is intended that the scope of the invention be defined by the claims appended hereto and their equivalents.

What is claimed is:

1. A method of training a machine-learning model, comprising: computing a data-fit loss L_data between model predictions and targets; computing, for a layer index n of the model, a scalar activation-energy field psi_n from a hidden-layer activation h_n, wherein psi_n comprises a sum of squares of components of h_n, j at a plurality of positions j; computing a recognition cost field C_RP, n from psi_n using a discrete operator Delta and a J-cost functional, wherein X_n, j is computed from abs((Delta psi_n)_j)/(psi_n, j+epsilon), a positive stabilized structural ratio X_stab, n, j is formed from X_n, j, and C_RP, n(x_j)=0.5(X_stab, n, j/X_opt+X_opt/X_stab, n, j) −1, where epsilon is a small positive constant; computing a recognition-cost coupling term X_opt times sum_j (psi_n, j*C_RP, n(x_j)); computing a golden-ratio resonance term phi\hat{ }(−n/2) sum_j psi_n, j; computing an action-gradient penalty term X_opt\hat{ }2 times sum_j (partial C_RP, n(x_j)/partial psi_n, j)\hat{ }2; summing the data-fit loss, the recognition-cost coupling term, the golden-ratio resonance term, and the action-gradient penalty term to form a total loss L_RT;
computing gradients of L_RT through an automatic-differentiation engine; and updating model parameters of the machine-learning model using the gradients so that subsequent forward passes of the machine-learning model use modified parameter values; wherein X_opt=phi/pi and phi=(1+sqrt(5))/2, and wherein coefficients for the recognition-cost coupling term, the golden-ratio resonance term, and the action-gradient penalty term are fixed by expressions comprising X_opt, phi\hat{ }(−n/2), and X_opt\hat{ }2 rather than selected by training-run search over candidate loss-term weights.

2. The method of claim 1, wherein X_opt=phi/pi is approximately 0.5149.

3. The method of claim 1, wherein computing gradients of L_RT comprises higher-order gradient construction preserving an action-gradient path through C_RP, n with respect to psi_n.

4. The method of claim 1, wherein the machine-learning model is a Transformer language model, the model predictions comprise token predictions, psi is derived from a last hidden token state, and the discrete operator Delta comprises a one-dimensional second-difference operator over token positions.

5. The method of claim 1, wherein the machine-learning model is a graph neural network, the model predictions comprise graph predictions, psi is derived from node embeddings, and the discrete operator Delta comprises a graph Laplacian over graph nodes.

6. The method of claim 1, wherein the machine-learning model is a segmentation model, the model predictions comprise segmentation outputs, psi is derived from a segmentation-oriented feature map, and the discrete operator Delta comprises a two-dimensional Laplacian over spatial positions.

7. A machine-learning training system comprising: a data-fit loss module configured to compute a data-fit loss L_data between model predictions and targets; an activation-energy derivation module configured to compute, for a layer index n of a machine-learning model, a scalar activation-energy field psi_n from a hidden-layer activation h_n, wherein psi_n comprises a sum of squares of components of h_n, j at a plurality of positions j; a recognition-cost computation module configured to compute a recognition cost field C_RP, n from psi_n using a discrete operator Delta and a J-cost functional, wherein X_n, j is computed from abs((Delta psi_n)_j)/(psi_n,j+epsilon), a positive stabilized structural ratio X_stab, n, j is formed from X_n, j, and C_RP, n(x_j)=0.5(X_stab, n, j/X_opt+X_opt/X_stab, n, j)−1, where epsilon is a small positive constant; a recognition-cost coupling module configured to compute a recognition-cost coupling term X_opt times sum_j (psi_n, j*C_RP, n(x_j)); a golden-ratio resonance module configured to compute a golden-ratio resonance term phi\hat{ }(−n/2) sum_j psi_n, j; an action-gradient penalty module configured to compute an action-gradient penalty term X_opt\hat{ }2 times sum_j (partial C_RP, n(x_j)/partial psi_n, j)\hat{ }2; and a gradient-computation and parameter-update module configured to form a total loss L_RT from the data-fit loss, the recognition-cost coupling term, the golden-ratio resonance term, and the action-gradient penalty term, compute gradients of L_RT through an automatic-differentiation framework, and update model parameters of the machine-learning model so that subsequent forward passes use modified parameter values;
wherein X_opt=phi/pi and phi=(1+sqrt(5))/2.

8. The system of claim 7, wherein the data-fit loss module, the activation-energy derivation module, the recognition-cost computation module, the recognition-cost coupling module, the golden-ratio resonance module, and the action-gradient penalty module are configured as differentiable tensor operations within an automatic-differentiation framework.

9. The system of claim 7, further comprising a hardware accelerator, optionally implemented as an application-specific integrated circuit, configured to compute at least one arithmetic portion of the recognition-cost coupling term, the golden-ratio resonance term, the action-gradient penalty term, or an intermediate tensor used to form the recognition-cost coupling term, the golden-ratio resonance term, or the action-gradient penalty term.

10. A non-transitory computer-readable medium storing instructions that, when executed by one or more processors, cause: computing a data-fit loss L_data between model predictions and targets; computing, for a layer index n of a machine-learning model, a scalar activation-energy field psi_n from a hidden-layer activation h_n, wherein psi_n comprises a sum of squares of components of h_n, j at a plurality of positions j; computing a recognition cost field C_RP, n from psi_n using a discrete operator Delta and a J-cost functional, wherein X_n, j is computed from abs((Delta psi_n)_j)/(psi_n, j+epsilon), a positive stabilized structural ratio X_stab, n, j is formed from X_n, j, and C_RP, n(x_j)=0.5(X_stab, n, j/X_opt+X_opt/X_stab, n, j)−1, where epsilon is a small positive constant; computing a recognition-cost coupling term X_opt times sum_j (psi_n, j*C_RP, n(x_j)); computing a golden-ratio resonance term phi\hat{ }(−n/2) sum_j psi_n, j; computing an action-gradient penalty term X_opt\hat{ }2 times sum_j (partial C_RP, n(x_j)/partial psi_n, j)\hat{ }2; summing the data-fit loss, the recognition-cost coupling term, the golden-ratio resonance term, and the action-gradient penalty term to form a total loss L_RT; computing gradients of L_RT through an automatic-differentiation engine; and updating model parameters of the machine-learning model using the gradients so that subsequent forward passes of the machine-learning model use modified parameter values; wherein X_opt=phi/pi and phi=(1+sqrt(5))/2, and wherein coefficients for the recognition-cost coupling term, the golden-ratio resonance term, and the action-gradient penalty term are fixed by expressions comprising X_opt, phi\hat{ }(−n/2), and X_opt\hat{ }2 rather than selected by training-run search over candidate loss-term weights.

11. The non-transitory computer-readable medium of claim 10, wherein the instructions define a J-cost function J(z)=0.5(z+1 /z)−1 and a recognition-cost computation that applies the discrete operator Delta to psi_n to compute Delta psi_n, computes a structural ratio X_n, j, normalizes the structural ratio by X_opt, and applies the J-cost function to produce C_RP, n.

12. The method of claim 1, wherein the machine-learning model is a classification model, the model predictions comprise class logits, and the data-fit loss L_data comprises cross-entropy.

13. The system of claim 7, wherein the system is a federated-learning system in which a plurality of client devices each compute the total loss L_RT from locally derived model predictions, local targets, local scalar activation-energy fields, local recognition cost fields, and corresponding gradients, and the gradient-computation and parameter-update module aggregates updates derived from the locally computed total losses across the plurality of client devices.

14. The system of claim 9, wherein the hardware accelerator comprises or is coupled to a neural processing unit to accelerate computation of at least one of the recognition-cost coupling term, the golden-ratio resonance term, or the action-gradient penalty term.

15. The system of claim 7, wherein the gradient-computation and parameter-update module computes gradients of the total loss L_RT with respect to model parameters of a quantized or partially quantized machine-learning model and updates the model parameters of the quantized or partially quantized machine-learning model during quantization-aware training using the gradients.

16. The method of claim 1, wherein the machine-learning model is a regression model, the model predictions comprise regression values, and the data-fit loss L_data comprises mean squared error.

17. The method of claim 1, wherein the machine-learning model is a convolutional neural network, the model predictions comprise class logits or other image-task outputs, psi is derived from a convolutional hidden representation comprising a feature map, and the discrete operator Delta comprises a two-dimensional Laplacian over spatial positions.

18. The method of claim 1, wherein the machine-learning model is a quantized or partially quantized model and gradients of the total loss L_RT with respect to model parameters of the quantized or partially quantized model are used to update the model parameters of the quantized or partially quantized model during quantization-aware training.

19. The method of claim 1, wherein a plurality of selected layers are used, and the recognition-cost coupling term, the golden-ratio resonance term, and the action-gradient penalty term each include per-layer contributions computed separately for each selected layer and aggregated across the plurality of selected layers.

20. The method of claim 19, wherein the total loss L_RT comprises a sum over the plurality of selected layers n such that, for each selected layer n, the selected layer contributes: (i) a coupling term comprising X_opt times sum_j psi_n, j C_RP, n(x_j), (ii) a golden-ratio resonance term comprising phi\hat{ }(−n/2) sum_j psi_n, j, and (iii) an action-gradient term comprising X_opt\hat{ } 2 —times sum_j (partial C_RP, n(x_j)/partial psi_n, j)\hat{ }2.
